(19) United States
(12) Patent Application Publication
(10) Pub. No.: US 2009/0099862 A1
(43) Pub. Date: Apr. 16, 2009

(54) SYSTEM, METHOD AND COMPUTER PROGRAM PRODUCT FOR PROVIDING HEALTH CARE SERVICES PERFORMANCE ANALYTICS

(75) Inventors: Andrew F. Fireman, Rockville, MD (US); Michael L. Glickman, Rockville, MD (US); Sridhar Gadhi, Clarksville, MD (US); Peddi R. Kanumuri, Elkridge, MD (US)

Correspondence Address: VENABLE LLP, P.O. BOX 34385, WASHINGTON, DC, 20043-9998, US

(73) Assignee: HEURISTIC ANALYTICS, LLC., Rockville, MD (US)

(21) Appl. No.: 11/873,247

(22) Filed: Oct. 16, 2007

(51) Int. Cl. G06Q 50/00

(52) U.S. Cl. 705/2; 705/7

(57) ABSTRACT

A system, method and computer program product for improving the delivery of healthcare services may include, e.g., but not limited to, in an exemplary embodiment, a) capturing data associated with at least one health care services event, wherein said data comprises at least one aspect of said at least one health care services event; b) categorizing, into at least one category, said at least one aspect of said at least one health care services event; c) analyzing said data associated with said categorized health care services event comprising: i) determining a correlation between said at least one aspect of said data to said at least one category, and ii) determining any cause and effect relationship between said at least one aspect and said at least one category; and d) recommending at least one course of action based on said at least one aspect having said correlation and said cause and effect relationship to said at least one category, is disclosed.

### BACKGROUND OF THE INVENTION

1. Field of the Invention

The present application relates generally to information processing systems and more particularly to medical information processing systems.

2. Related Art

Many different information technology tools are available to support delivery of healthcare.

Conventionally, patient intake and billing systems track various information about a patient. Billing systems, at a hospital for example, support efficient billing of patients and insurance companies for healthcare services.

Medical records, both paper based and electronic can hold information about patients. The advent of electronic medical records has eased the storage, transmission and archival of patient information.

Conventionally, physicians have physically examined patients and draw upon a vast array of personal knowledge gleaned from years of study to identify problems and conditions experienced by patients, and to determine appropriate treatments. Sources of support information traditionally included other practitioners, reference books and manuals, relatively straightforward examination results and analyses, and so forth. Over the past decades, a wide array of further reference materials have become available to the practitioner that greatly expand the resources available and enhance and improve patient care.

For example, diagnostic resources available to physicians and other caretakers include databases of information including disease states, and information on how to recognize such states. Similarly, databases can identify drug interactions, predispositions for disease, and so forth. Some reference materials are available at no cost to health care providers, while others may be available by subscription.

Various data acquisition techniques such as, e.g., or not limited to, X-Ray, magnetic resonance imaging (MRI), and computer tomography scan (CT Scan) may capture patient related data, avoiding in some cases need for surgery. All of these techniques have added to the vast array of resources available to physicians, and have greatly improved the quality of medical care.

Thus, conventional medical care systems assist with patient care, financial management, and health care institution management.

By any measure, the increasing cost of health care over recent years in developed nations is worrisome and clearly unsustainable. Health expenditures for the United States total about $2 trillion USD each year. By 2015, annual health expenditures are anticipated to double to $4 trillion USD and represent one-fifth of the gross domestic product (GDP) of the United States. Among the factors propelling the rise in costs are increases in life expectancy and the size of an aging Baby Boom population. See, e.g., US Centers for Medicare & Medicaid Services: National Health Care Expenditures Projections, NIH, 2005-2015.

Medical technology and care provided, especially during the last six months of life, contribute significantly to health care cost increases. However, technology also promises real improvements in both costs and quality that can be achieved by leveraging data and information and making the delivery of care more effective and efficient.

It has been 15 years since the landmark Institute of Medicine report, The Computer-Based Patient Record, prompted development of today's electronic health record. The next new horizon will be the revolutionary changes that will enable personalized medicine, or more significantly, personalized health.

A milestone scientific achievement of the 21^{st} century has been the sequencing of the human genome, which has led to the new sciences of genomics and proteomics. The study of polymorphisms, or genomic changes associated with particular diseases, promises vast improvements in the efficacy and efficiency of health care delivery.

Glimpses of this substantial step forward are already evident in the treatment of cancer. Genetic testing, coupled with the many choices of available chemotherapy drugs, has led to personalized drug regimens and treatment protocols that are becoming more effective by the month. These changes in procedure protocols will cause what is done for a patient to be more effective and efficient and why it was to be done, to be more clearly understood.

### SUMMARY OF THE INVENTION

An exemplary embodiment of the present invention sets forth a system adapted to iteratively evolve to deliver quality care more efficiently, by learning from a plurality of control parameters. An exemplary embodiment of the present invention sets forth a system, method and/or computer program product for continually improving by learning and providing recommendations to maximize use of health care service resources via data capture of aspects of health care services data, categorization, analysis, correlation and cause and effect analysis to prepare recommendations and/or optional notifications.

An exemplary system, method and/or computer program product is set forth for improving the delivery of healthcare services may include: a) capturing data associated with at least one health care services event, wherein the data may include at least one aspect of the at least one health care services event; b) categorizing, into at least one category, the at least one aspect of the at least one health care services event; c) analyzing the data associated with the categorized health care services event may include: i) determining a correlation between the at least one aspect of the data to the at least one category, and ii) determining any cause and effect relationship between the at least one aspect and the at least one category; and d) recommending at least one course of action based on the at least one aspect having the correlation and the cause and effect relationship to the at least one category.

According to one exemplary embodiment, the method may include where the (a) may include capturing data associated with at least one health care services event, wherein the at least one health care services event may include at least one of: at least one event; a plurality of events; at least one pre-operative event; at least one post-operative event; at least one operative event; at least one pre-procedure event; at least one post-procedure event; at least one procedure; at least one emergency room procedure; at least one triage event; at least one nursing station event; at least one patient/nurse interaction event; and/or at least one healthcare provider/patient interaction event.

According to one exemplary embodiment, the method may include where the (a) may include capturing the at least one aspect of the data, wherein the at least one aspect may include: at least one temporal duration; at least one quantity of time; at least one quantity of health care resources used; at least one type of health care resource used; at least one health care provider preference; at least one health care facility preference; at least one preference; at least one norm; at least one procedure; a minimum/mean/maximum quantity of at least one resource; at least one location; at least one proximity between a plurality of resources; at least one change of location by a resource; at least one rate of change of the location; at least one movement from a first location to a second location of a resource; at least one regulatory requirement; at least one order; and/or at least one protocol.

According to one exemplary embodiment, the method may include where the (a) may include capturing the data, wherein the data relates to at least one of a plurality of entities may include at least one of: a health care resource, a patient, a health care provider, a staff member; a location; a data processing system; a healthcare system; a person; a system; a supply; and/or at least one piece of equipment.

According to one exemplary embodiment, the method may include where the (a) may include at least one of tracking the data, collecting the data; aggregating the data; storing the data; transmitting the data; capturing the data over time; capturing the data by location; and/or capturing the data by location and time.

According to one exemplary embodiment, the method may include where the (b) may include at least one of: i) comparing the at least one aspect of the health care services event to at least one preference, and assigning the at least one aspect of the at least one health care services event to the at least one category based on the comparing; ii) comparing a first at least one aspect of the health care services event to a second at least one aspect of a second the health care services event, and assigning the first at least one aspect of the health care services event to the at least one category based on the comparing; and/or iii) comparing at least one aspect of a first the health care services event to at least one aspect of a second the health care services event, and assigning the at least one aspect of the first health care services event to the at least one category based on the comparing.

According to one exemplary embodiment, the method may include where the comparing may include: comparing to the at least one preference, wherein the preference may include at least one of: comparing whether a duration of the health care services event was completed in an allotted time preference; comparing health care resources used during the health care services event to an allotted amount of resources preference; comparing an occurrence of the health care services event to a defined point in time preference; comparing a proximity aspect to a defined proximity preference; and/or comparing a location of the health care services event to a defined location preference.

According to one exemplary embodiment, the method may include where the comparing may include: comparing to the at least one preference, wherein the preference is chosen by at least one of: a health care facility; a physician preference; a nurse preference; a health care provider preference; an iterative preference; and/or a recommended preference.

According to one exemplary embodiment, the method may include where the (b) may include: categorizing along at least one of: a continuum of the at least one categories, wherein the continuum may include at least one of: a multi-variate category; a range of categories; a continuum from optimal to unacceptable; and/or a discrete set of the categories may include at least one of: a binary category; and/or at least three discrete categories.

According to one exemplary embodiment, the method may include where the (c) may include: performing at least one of: stochastic analysis, and/or Bayesian analysis; or deterministic analysis.

According to one exemplary embodiment, the method may include where the (c) may include at least one of: iteratively improving the at least one aspect; learning an improved health care preference; performing heuristic analysis on the data; and/or iteratively improving a preference related to the at least one healthcare services event.

According to one exemplary embodiment, the method may include where the (d) may include at least one of: i) recommending at least one change to the capturing may include at least one of: adding a new at least one datapoint to capture, and/or deleting an existing of the at least one datapoint; ii) recommending at least one change to the capturing may include at least one of: adding a new at least one aspect, deleting an existing of the at least one aspect, and/or modifying the at least one aspect; iii) recommending at least one change to the categories may include at least one of: adding a new at least one category, deleting an existing of the at least one category, and/or modifying the at least one category; and/or iv) recommending the at least one course of action to effect a change in the at least one health care services event.

According to one exemplary embodiment, the method may include where the (d) may include at least one of: i) minimizing at least one of an underlying activity, and/or subevent leading to at least one of a negative data point and/or a negative aspect, wherein the negative datapoint and/or the negative aspect is associated with any negative category; and/or ii) maximizing at least one of an underlying activity and/or subevent leading to a at least one of a positive data point and/or a positive aspect, wherein the positive datapoint and/or the positive aspect is associated with any positive category.

According to one exemplary embodiment, the method may include where the (d) may include at least one of recommending in at least one of real time, and/or retroactively; and/or recommending the course of action directed at improving utilization of health care facility resources.

According to one exemplary embodiment, the method may further include: e) notifying at least one entity wherein the notifying may include at least one of: i) notifying of the at least one course of action; ii) alerting the at least one entity; iii) providing output to at least one entity; iv) providing interactive prompting to the at least one entity; v) allowing interactive deferral by the at least one entity; vi) providing prompting to the at least one entity; and/or vii) providing output data in an easily accessible and interactive format.

According to one exemplary embodiment, the method may include where the (e) may include i) providing a dashboard user interface application.

According to one exemplary embodiment, the method may include where the dashboard may include at least one of: i) providing an executive information system (EIS); ii) providing a graphical user interface (GUI); iii) providing an interface customized to user needs and/or preferences; iv) providing a dashboard and/or interactive, easy to use user interface elements; v) providing an easy to change and/or customize interface; and/or vii) a dashboard customizable for the needs of an entity.

According to one exemplary embodiment, the method may further include e) ranking, based on at least one metric, at least one of: a plurality of entities, at least one healthcare service facility, at least one department of the at least one healthcare service facility, the at least one healthcare service event; and/or the at least one health care service event across a plurality of healthcare service facilities, wherein the ranking may include at least one of a comparative ranking and/or a benchmark.

According to one exemplary embodiment, the method may include where the notifying may include at least one of: notifying in at least one of real time, and/or retroactively; and/or notifying of the course of action directed at improving utilization of health care facility resources.

According to one exemplary embodiment, the method may include where the (c) may include: optimizing utilization of health care service resources associated with the at least one health care services event.

According to one exemplary embodiment, the method may include where the data may include location based data.

According to one exemplary embodiment, the method may include where the location based data may include at least one of: a location of each of the plurality of entities; a temporal relationship associated with the each of the plurality of entities being located at the location; a temporal extent of the each of the plurality of entities being located at the location; a proximity between at least two of the plurality of entities; a temporal extent of the proximity; a temporal relationship associated with the proximity; a location of the at least one health care service delivery event; a temporal extent of the at least one health care service delivery event; and/or a temporal relationship associated with the health care service delivery event.

According to one exemplary embodiment, the method may include where the location based data may include at least one of: location based data in at least two dimensions; location based data in at least three dimensions; location based data in at least two dimensions plus time; a geosynchronous positioning satellite (GPS) data; a real time location system (RTLS) data; a radio frequency identification (RFID) data; a wireless and/or wired network based data; a WI-FI based location data; a WI-MAX based location data; an ultra-wideband location data; and/or an auto identification system (AIS).

According to one exemplary embodiment, the method may include where the (a) may include: capturing the data wherein the data may include at least one of: at least one medical record; at least one physical record; at least one electronic record; a patient medical record; at least one electronic medical record; at least one personal health record (PHR); at least one location data; at least one temporal data; at least one radio frequency identification (RFID) device; at least one health level seven (HL-7) protocol message; at least one data from any hospital system; at least one standards-based healthcare data; at least one American Society for Testing and Materials (ASTM) based data; at least one Digital Imaging and Communications in Medicine (DICOM) based data; at least one entity preference; at least one healthcare facility protocol; at least one protocol; at least one order; at least one procedure; at least one bar code; at least one regulatory data; at least one other input from an existing hospital information system; at least one aspect of data; at least one demographic of an entity; at least one experience data; at least one expertise data; and/or data from another system.

According to one exemplary embodiment, the method may include where the health care services event is delivered by a health care resource may include at least one of: a healthcare provider; a healthcare worker; a physician; a nurse; a care giver; a surgeon; an orderly; transportation; a therapist; an occupational therapist (OT); a physical therapist (PT); a pulmonary therapist (PT); a pulmonologist; an oncological surgeon; a cardiac surgeon; an executive; an administrator; an ancillary service provider; a physician's assistant; an emergency medical technician (EMT); a first responder; a police officer; and/or a clinician.

According to one exemplary embodiment, the method may include where the health care services event is delivered by a health care resource may include at least one of: a medical device; a medical supply; a piece of equipment; a specimen; a lab specimen; a medication; an instrument; a bed; a gurney; an imaging device may include at least one of an X-Ray device, a CT scan device, an MRI image device, a scanned image device, an electronic image device, and/or another image device; a waveform may include at least one of an EKG, an ECG, another waveform; a medical device may include at least one of a pulmonary function monitor, a heart monitor, a wireless RF monitor, and/or a wired monitor; a physical record; an electronic medical record; a personal health record; a patient medical record; and/or an RFID tag.

According to one exemplary embodiment, the method may include where the health care services event is delivered by a health care facility may include at least one of: a hospital; a health care system; an integrated delivery network; a plurality of hospitals; a nursing home; a critical care service; an assisted living facility; a hospice service; a physical therapy clinic; a clinic; a medical supplier; a pharmacy; a doctor's office; a dental office; a home; a home health care service; and/or a health care clinic.

According to one to one exemplary embodiment, the method may include where the health care services event is delivered by a health care facility may include a plurality of departments may include at least one of: an operating room; a nursing station; an emergency department; a critical care unit; a cardiac care unit; an intensive care unit; a nursery; a pediatric department; a maternity department; a surgery department; a surgery center; an oncology department; a geriatrics department; a physical therapy department; an occupational therapy department; an orthopedic department; a radiology department; a ward (inpatient); a clinic (outpatient); a medical office; a physician's office; a medical specialty department; a health care facility room; a recovery room; a waiting room; a pre-operative room; another department; a post-operative room; and/or a patient room.

According to one exemplary embodiment, the method may further include: e) identifying at least one health care service preference relating to the at least one aspect of the at least one health care services event.

According to one exemplary embodiment, a computer program product embodied on a computer readable medium may include program logic which when executed on a processor may perform a method for improving the delivery of healthcare services, where the method may include: a) capturing data associated with at least one health care services event, wherein the data may include at least one aspect of the at least one health care services event; b) categorizing, into at least one category, the at least one aspect of the at least one health care services event; c) analyzing the data associated with the categorized health care services event may include: i) determining a correlation between the at least one aspect of the data to the at least one category, and ii) determining any cause and effect relationship between the at least one aspect and the at least one category; and d) recommending at least one course of action based on the at least one aspect having the correlation and the cause and effect relationship to the at least one category.

According to one exemplary embodiment, the system for improving the delivery of healthcare services may include: means for capturing data associated with at least one health care services event, wherein the data may include at least one aspect of the at least one health care services event; means for categorizing, into at least one category, the at least one aspect of the at least one health care services event; means for analyzing the data associated with the categorized health care services event may include: means for determining a correlation between the at least one aspect of the data to the at least one category, and means for determining any cause and effect relationship between the at least one aspect and the at least one category; and means for recommending at least one course of action based on the at least one aspect having the correlation and the cause and effect relationship to the at least one category.

According to one exemplary embodiment, the system may further include where: an analytics system adapted for assisting an entity to optimize resource utilization via a performance analytics engine (PAE) infrastructure and services system, the analytics system may include at least one of: at least one transaction source data feed (TSDF) non-location based ordering system, at least one transaction source extractor means for extracting transaction data from the transaction source data feed, at least one transaction source normalizer means for preparing data for analysis, and for normalizing transaction data from the transaction source extractor, and at least one transaction source aggregation engine means for homogeneous collecting, screening, and sorting through large volumes of normalized transaction data from the transaction source normalizer, wherein the at least one transaction source aggregation engine means uses proprietary algorithms based on at least one of Bayesian analysis and/or heuristic methods; and/or at least one location source data feed (LSDF) location based system may include data relating to location of at least one of a patient location, a device location, and/or a clinician location, at least one location source extractor means for extracting location data from the location source data feed, at least one location source normalizer means for normalizing location data from the location source extractor, and at least one location source aggregation engine means for collecting heterogeneously, screening, and sorting through large volumes of normalized location data from the location source extractor, wherein the at least one location source aggregation engine uses proprietary algorithms based on Bayesian analysis and/or heuristic methods; and at least one interface means for interactive entry and/or acceptance by at least one of an administrative user, a healthcare provider, a support staff person, and/or a health care facility system, wherein the interactive entry and/or acceptance is of at least one of at least one expected event, at least one rule, at least one time measure, at least one outcome, and/or at least one preference.

According to one exemplary embodiment, the system may include where the transaction source data may include at least one data from at least one transaction system regarding at least one of: an admission/discharge/transfer; an order, a result, a computerized physician order entry (CPOE), a scheduled event, an appointment, a patient movement, and/or a device movement.

According to one exemplary embodiment, the system may include where the at least one LSDF may include location source data may include a location data set relating to a location of at least one of: at least one patient; at least one person; at least one employee; at least one non-employee; at least one contractor; at least one resident; at least one healthcare worker; at least one healthcare provider; at least one living being; at least one supply; at least one piece of equipment; and/or at least one device.

According to one exemplary embodiment, the system may include where the performance analytics engine may include at least one of: at least one means for moving and/or extracting data; at least one means for normalizing data; and/or at least one means for aggregating data.

According to one exemplary embodiment, the system may include where the performance analytics engine includes at least one of: at least one means for matching data and expected events; and/or at least one means for matching expected events and actual events.

According to one exemplary embodiment, the system may include where the performance analytics engine includes at least one means for preparing at least one of an alarm, a notification, a recommendation, and/or a message to at least one of individuals and/or systems.

According to one exemplary embodiment, the system may include where the performance analytics engine includes at least one means for delivering a message to at least one of a person, interface and/or a system.

According to one exemplary embodiment, the system may include where the performance analytics engine includes at least one of: at least one means for updating an algorithm; at least one means for learning; at least one means for providing a heuristic method; at least one means for correlating; at least one means for determining a relative importance of a deviations; at least one application service provider (ASP) service; at least one software as a service (SaaS) based service; at least one on demand service offering; at least one utility computing offering; at least one service oriented architecture (SOA) based offering; at least one knowledge base (KB); at least one rules database; at least one inference engine; at least one Bayesian inference engine; and/or at least one means for providing an expert system.

According to one exemplary embodiment, the system may include where the at least one performance analytics engine may include at least one of: means for matching clinical orders and/or procedures, wherein the clinical orders and/or procedures comprise at least one of: a lab test, an x-ray, an image, a magnetic resonance image (MRIs), a computer tomography (CT) scan, an ultrasound, patient data, a scheduled event, an unscheduled event, a movement, a transfer, and/or an expected event; means for matching an expected event with an actual event; means for comparing an expected event with actual event; means for matching expected and actual event deviations; means for preparing an alarm, a message, an alert, a prompt, an indication, a recommendation, and/or a notification, wherein the means for preparing may include means for using a delivery mechanism to notify individuals of deviations with or without appropriate remedial actions; means for preparing an alarm and/or a message using a delivery mechanism to notify health care facility systems; and means for updating an algorithm, for using a heuristic method, for learning, for iteratively learning, for correlating, and/or for determining a relative importance of a deviation.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of various exemplary embodiments including a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary healthcare hardware system environment illustrating an exemplary client-server based, exemplary application service provider (ASP) health care information system providing performance analytics according to an exemplary embodiment of the present invention;

FIG. 2 depicts an exemplary software architecture illustrating an exemplary service oriented architecture (SOA) healthcare services performance analytics system according to an exemplary embodiment of the present invention;

FIG. 3 depicts an exemplary performance analytics system illustrating an exemplary interaction between exemplary modules and submodules of an exemplary nondeterministic healthcare services delivery heuristic performance analytics system according to an exemplary embodiment of the present invention;

FIG. 4 depicts a flow diagram of an exemplary performance analytic process illustrating an exemplary data collection, analysis and output method according to an exemplary embodiment of the present invention;

FIG. 5A depicts an exemplary radio frequency identification (RFID) system illustrating exemplary location based health care data collection according to an exemplary embodiment of the present invention;

FIGS. 5B, 5C, 5D, 5E and 5F depict floorplan and legend diagrams, which in combination, illustrate an exemplary depiction of a health care facility environment, depicting various outfitted with location based sensing devices, as well as location based system device for identifying the location of one of these devices;

FIG. 6 depicts an exemplary computer system according to an exemplary embodiment of exemplary components of a system that could be used as a client, server, network, and/or other component of the systems according to an exemplary embodiment of the present invention;

FIG. 7 depicts an exemplary knowledge intelligence system illustrating an exemplary system which may be used as a subcomponent of a performance analytics health care data analysis system according to an exemplary embodiment of the present invention;

FIG. 8 depicts an exemplary artificial neural network including a number of units and connections between them, implemented by hardware and/or software, and graphically represented as shown, according to an exemplary embodiment of the present invention;

FIG. 9 depicts an exemplary neural network, which may be implemented in hardware and/or software, according to an exemplary embodiment of the present invention;

FIG. 10 depicts an exemplary open knowledge cell structure in accordance with an exemplary embodiment of the present invention;

FIG. 11 depicts an exemplary illustration of storing an (n×n) knowledge cell using a (3×n) unit storage space, where each value of the decision function Dⱼ determines which action function Aᵢ to be used for a factor Fⱼ;

FIG. 12 depicts an exemplary knowledge-mining method in accordance with an exemplary embodiment of the present invention;

FIG. 13 depicts an exemplary healthcare services performance analytics service provider workflow according to an exemplary embodiment of the present invention; and

FIG. 14 depicts an exemplary dashboard diagram, which in an exemplary embodiment may include a graphical user interface having operational protocols and/or procedural preferences and for a given procedure, a graphical indication of progress through the health care event.

### DETAILED DESCRIPTION OF VARIOUS EXEMPLARY EMBODIMENTS OF THE PRESENT INVENTION

Various exemplary embodiments of the invention including preferred embodiments are discussed in detail below. While specific exemplary embodiments are discussed, it should be understood that this is done for illustration purposes only. A person skilled in the relevant art will recognize that other components and configurations can be used without parting from the spirit and scope of the invention.

An exemplary embodiment of the present invention enables a breakthrough in medical information systems capabilities by improving how, when and where healthcare providers deliver care to a patient. These improvements may be achieved by collecting data from dozens of systems and providing consolidated patient-centered views of planned procedures, patient treatment activities, movements and associated activities and then comparing the consolidated views to actual patient treatment, movements and associated activities and reporting differences directly, so that the differences identified may be acted upon in real time rather than retrospectively. For example, according to an exemplary embodiment, if an imperative item is missing from a surgical cart, the absence of the item maybe noted and may be remediated before an operation begins, rather than causing an operation to be interrupted, delayed and/or cancelled.

There have been many implementations of RFID systems in medical settings during the past few years. These implementations have been to solve a specific problem such as, e.g., or not limited to, tracking equipment locations thereby improving equipment utilization, or patient tracking in the Emergency Department to improve utilization. These implementations make little use of external data from other operational medical information systems.

The scope of this medical information system, according to an exemplary embodiment of the present invention, is unprecedented. Data may be collected from dozens of systems and thousands of locations. The millions of resulting data elements may be analyzed based on probabilism, Bayesian methodologies and heuristics. Medicine may be as much an art as a science, and thus there are a wide variety of outcomes that according to an exemplary embodiment, may be measured, correlated and/or otherwise weighted to avoid regression to the mean.

In an exemplary embodiment of the present invention, outliers including data associated with specific personalized patient regimens and treatment protocols may not be normalized or ignored, but may become key to producing improvements in quality and efficiency. Previously, clinical and administrative practitioners considered these two goals mutually exclusive.

An exemplary embodiment of the present invention may combine data from various departmental and enterprise transaction systems in real time and may create a feedback loop that applies Bayesian methods to continuously revise parameters of prior knowledge based on actual events and outcomes. These outcomes may be, in an exemplary embodiment, physical, operational and/or clinical.

Based on an individual hospital's preferences, in an exemplary embodiment, goals and existing operations, an exemplary embodiment of the present invention, an exemplary system may establish expected probabilistic outcomes and may collect a large quantity of data points that are filtered and analyzed in real time, rather than retrospectively, using an exemplary embodiment of the present invention's proprietary algorithms and methods. The result may be a nondeterministic learning system that may continuously alter and/or modify probabilities and distributions based on real time data collection to generate improved outcomes such as, e.g., or not limited to, increased operating room utilization, decreased nursing time required per patient for a given level of acuity, support to individual physician preferences, personalized patient regimens and treatment protocols, reducing time to discharge a patient and turnover the room while maintaining or improving patient safety and satisfaction, to name but a few examples.

A fundamental, exemplary, component of the invention enabling real time, continuous outcomes improvement may be the delivery of, e.g., real time recommendation, notifications, and/or message alerts to, e.g., clinicians, allied health professionals and/or support staff, via a variety of means (e.g., email, text, wireless, etc.). The system may use communications modalities that can be based on individualized personal preferences of the staff, as well as a standards-based Internet capability known as IP presence. Thus, deviations in expected outcomes may be immediately identified and the personnel and systems that can effectively alter the current state may be notified immediately, rather than hours or days after the fact, as may be the case in conventional systems' retrospective analyses.

An exemplary embodiment of the present invention may provide for a system that may learn over time in, e.g., at least two dimensions. First by improving the underlying analysis and outcome parameters based on the real time data collected and analyzed, and second by expanding the effectiveness of the system by adding additional factors such as, e.g., or not limited to, patient and equipment movement. The system may be based on advanced software engineering techniques and may be employ a Service Oriented Architecture (SOA) according to an exemplary embodiment of the present invention, that may allow improvements that may be added to be backward compatible.

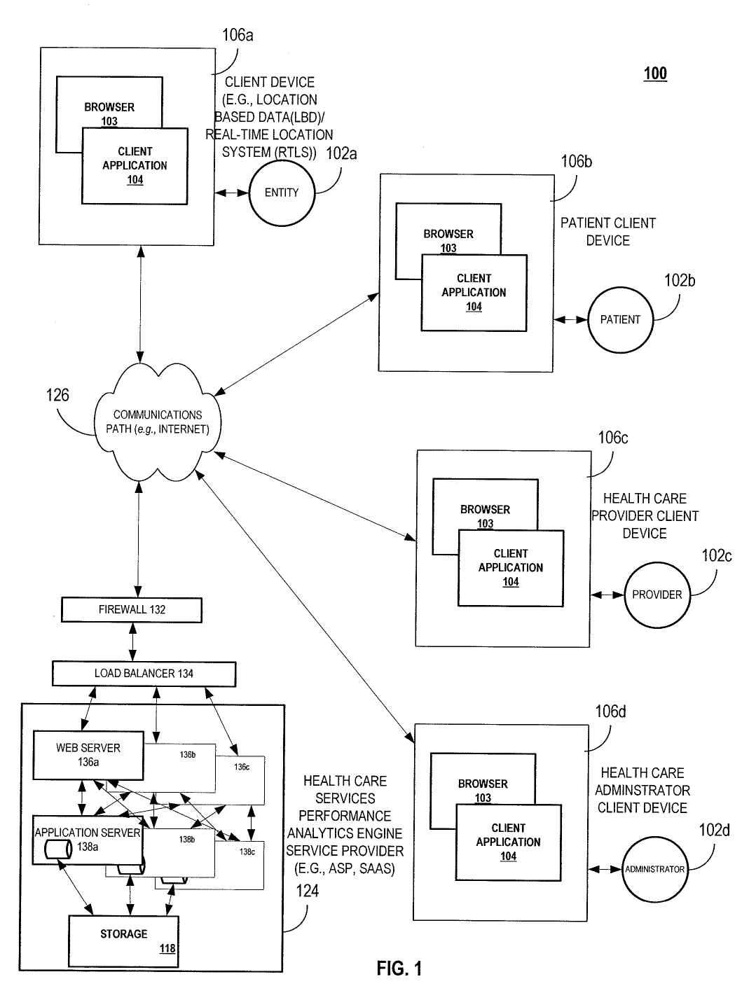

FIG. 1 depicts an exemplary diagram 100 illustrating an exemplary healthcare services performance analytics engine service provider hardware system architecture environment illustrating an exemplary client-server based, exemplary application service provider (ASP) health care information system providing performance analytics according to an exemplary embodiment of the present invention. Although illustrated in an exemplary ASP client server network, any other well know network design such as, e.g., but not limited to, peer-to-peer, hierarchical, etc. may also be used.

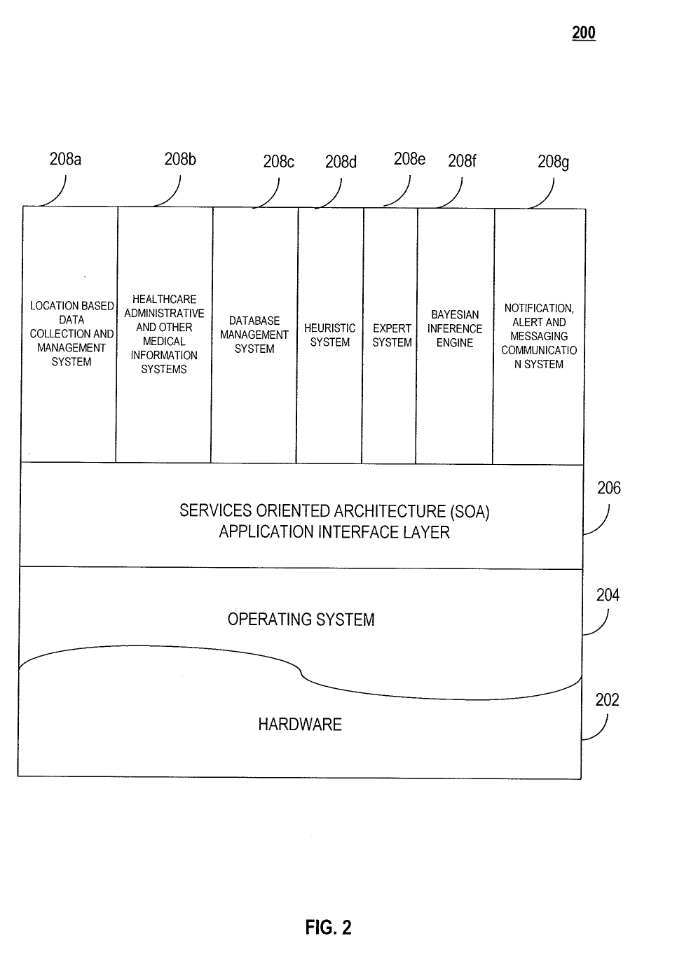

FIG. 1 depicts an exemplary embodiment of a diagram 100 illustrating an exemplary high-level view of an exemplary health care services performance analytics system 100 according to an exemplary embodiment of the present invention. According to an exemplary embodiment, a health care services performance analytics service provider 124 may, e.g., including but not limited to, capture, store, and/or analyze data from and may provide recommendations and/or notifications to a plurality of entities. Exemplary but non-limiting entities may be displayed for illustrative purposes. According to an exemplary embodiment, the health care services performance analytics service provider 124 may be used to distribute interactive multimedia content to one or more health care entity devices 106a, 106b, 106c, 106d (collectively referred to 106), for interactive delivery for viewing by one or more entities 102a, 102b, 102c and 102d (collectively referred to as entities 102). According to an exemplary embodiment, the system may be represented by a client-server network design where the health care services performance analytics service provider 124 may include one or more servers including, e.g., but not limited to, web servers 136a-136c, application servers 138a-138c, coupled via, e.g., load balancer 134 and/or firewall 132, as well as a communications network 126, and one or more entity devices 106a, 106b, 106c, and 106d (collectively 106) may be client devices, which according to an exemplary embodiment, may also include, in an exemplary embodiment, a health care data capture device 116 (not shown), which may provide location based data (as described further with reference to FIG. 2). One example of a location based data capture device 208a may be a radio frequency identification (RFID) system, or other system, as may be incorporated as a separate device 116, or may be associated with an entity 102a. Client devices 106 may be coupled to the health care services performance analytics service provider 124 via a communications path (such as, e.g., a network, such as, e.g., the Internet). According to another exemplary embodiment (not shown), the health care services performance analytics service provider 124 could be represented by any of a number of well-known hardware network architectures including, but not limited to, a peer-to-peer network design, a client-server based architecture, an application services (ASP) based offering, by which notification and/or informational content may be distributed from one computing device to another (for a peer-to-peer embodiment, from physician-to-patient, patient-to-physician, healthcare provider to administrator, etc., for example). According to another exemplary embodiment (not shown), a standalone system may be also possible where the health care entity data captured may be captured and analyzed via a device having a storage medium such as, e.g., a computer readable medium, such as, e.g., but not limited to, a compact disc read only memory (CD-ROM), and/or a digital versatile disk (DVD), etc. Any other hardware architecture such as, e.g., but not limited to, a services oriented architecture (SOA), according to an exemplary embodiment of the present invention.

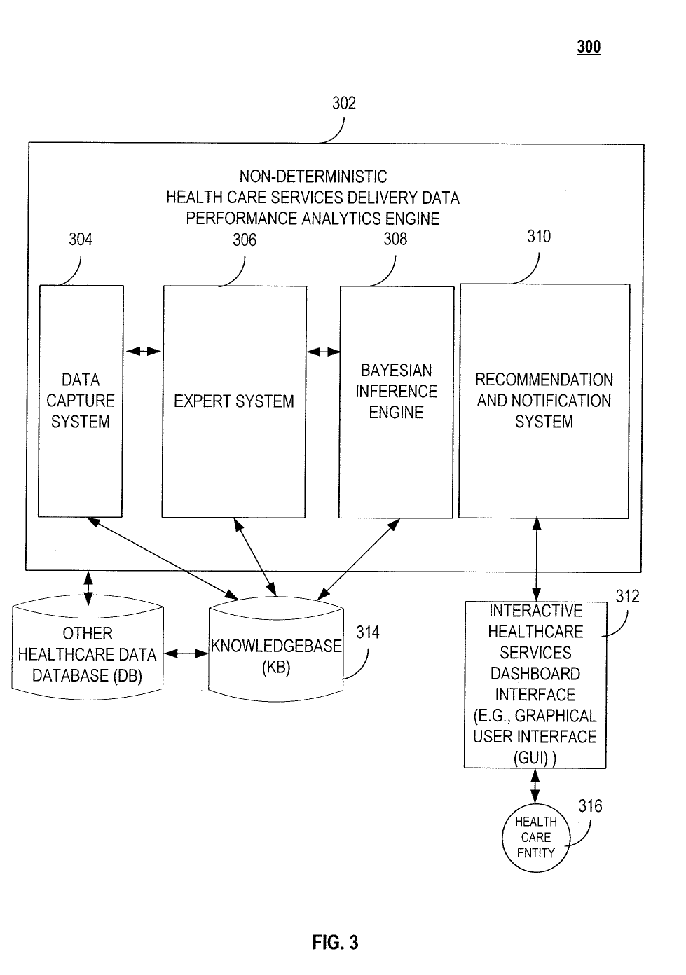

As shown in FIG. 1, in an exemplary embodiment, an end-user 102 may interact with health care services performance analytics engine service provider system 124 via a client device, which may provide an interface to the user such as, e.g., but not limited to, a graphical user interface (GUI), which may execute on the client device 106 via a client application 104, which may in an exemplary embodiment, be browser-based 103. The health care services performance analytics service provider 124 according to an exemplary embodiment of the present invention may distribute recommendations based on recommendations generated by analyzing data captured and notifications may be transmitted via the network 126 to client devices 106. In an exemplary embodiment, the end-user 102 may be coupled to the health care service performance analytics service provider 124 via one or more devices including, e.g., but not limited to, a firewall 132, one or more load balancers 134, one or more web servers 136, and one or more application servers 138, which may include storage or may access a storage device 118 such as, e.g., but not limited to, a database (DB), a knowledgebase (KB) 314 (discussed further below with reference to FIG. 3), etc. The devices may be coupled to one another over a network 126 such as, e.g., but not limited to, the Internet. The health care services performance analytics engine service provider system 124, according to an exemplary embodiment, may include, one or more storage devices, including, one or more web servers 136, and one or more application servers 138, which may include storage or may access a storage device 118 such as, e.g., or not limited to, a storage area network (SAN) device. The data storage device 118 may store files, such as, e.g., but not limited to, captured data, analyzed and categorized health care data, recommendations and/or notifications. Various forms of data may be captured. In one exemplary embodiment, the storage device 118 may include a cluster of intelligent storage nodes.

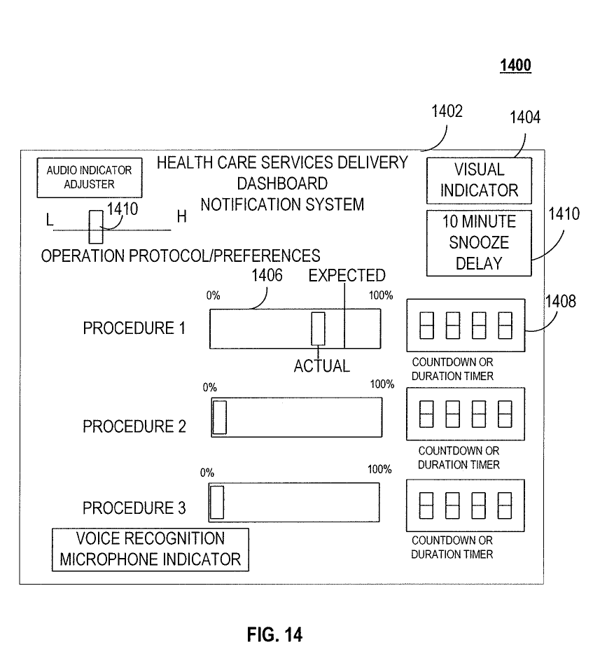

In one exemplary embodiment, the storage device 118 may communicate with web servers 136a, 136b, 136c and browsers 103 on remote devices 106a, 106b, 106c and 106d (browsers 103 may include, e.g., but not limited to, Microsoft Internet Explorer, Netscape Navigator, Mozilla, FireFox, etc.) operating on end-user computer devices 106 via the standard Internet hypertext transfer protocol (“HTTP”) and universal resource locators (“URLs”). Although the use of HTTP may be described herein, any well known transport protocol may be used without deviating from the spirit or scope of the invention. For the users 102 to access analyzed healthcare services performance analytics data content, the end-users, through end-user computer devices 106, may generate hyper text transfer protocol (“HTTP”) requests to the content origin server 124 to obtain hyper text mark-up language (“HTML”) files. In addition, to obtain large data objects associated with those text files, the end-user, through end user computer devices 106, may generate HTTP requests (via browser 103) to the storage service device 118. For example, the end-user may download from the health care services performance analytics service provider 124 servers 136, 138, health care data, or interactive recommendations and/or notifications. When the user “clicks” to select a given URL, the performance analytics data may be downloaded from the storage device 118 to the end-user device 106, for interactive access via browser 103, and/or client application 104, using an HTTP request generated by the browser 103 to the storage service device 118, and the storage service device 118 may then download the analyzed data, recommendations and/or notifications to the end-user computer 106. In some cases, according to an exemplary embodiment, a dashboard interface (discussed further below with reference to FIG. 14) may be provided to allow the user interactive access. In one exemplary embodiment, storage device 118 may include a storage cluster, which may include distributed systems technology that may harness the throughput of, e.g., but not limited to, hundreds of CPUs and storage of, e.g., but not limited to, thousands of disk drives. As shown in FIG. 1, healthcare services performance analytics data may be captured from devices using, e.g., location based capture devices 208a, and may be analyzed and recommendations and/or notifications may be provided to end users via the network 126. In one exemplary embodiment, the load balancing fabric 134 may include, e.g., but not limited to, a layer four (“L4”) switch, according to an exemplary embodiment of the present invention, etc. In general, L4 switches may be capable of effectively prioritizing TCP and UDP traffic, according to an exemplary embodiment of the present invention. In addition, L4 switches, which incorporate load balancing capabilities, may distribute requests for HTTP sessions among a number of resources, such as, e.g., or not limited to, web servers 136a, 136b, 136c. For this exemplary embodiment, the load balancing fabric 134 may distribute upload and download requests to one of a plurality of web servers 136 based on availability. The load balancing capability in an L4 switch is currently commercially available.

FIG. 2 depicts an exemplary diagram 200 illustrating an exemplary software architecture illustrating an exemplary services oriented architecture (SOA) healthcare services performance analytics system according to an exemplary embodiment of the present invention. Various exemplary services oriented architecture systems may be provided, since various SOA systems are commercially today from such vendors as IBM Corporation of Armonk, N.Y. USA.

A service-oriented architecture (SOA) is an architectural design pattern that concerns itself with defining loosely-coupled relationships between producers and consumers. While it has no direct relationship with software, programming, or technology, it's often confused with an evolution of distributed computing and modular programming. SOA is an architecture that relies on service-orientation as its fundamental design principle. In an SOA environment independent services can be accessed without knowledge of their underlying platform implementation. These concepts can be applied to business, software and other types of producer/consumer systems.

FIG. 2 depicts an exemplary embodiment of a software architecture diagram 200, which may include a hardware layer 202, an operating system layer 204, a service oriented architecture enablement middleware layer 206, and various applications 208. In an exemplary embodiment, the healthcare services performance analytics system 124 may include a location based data collection and management system 208a, a healthcare administrative and other medical information systems 208b (including any of various well known healthcare delivery information systems as conventionally used in health care services delivery), a database management system 208c such as, e.g., or not limited to, an Oracle database available from Oracle Corporation, or DB2 available from IBM Corporation, a heuristic system 208d providing intelligent analytics and learning capabilities, expert system 208e, a Bayesian inference engine 208f, and a notification, alert, recommendations, and/or messaging communication system, according to an exemplary embodiment of the present invention.

Every business comprises core and non core functions. Core functionality changes very less frequently and the non core changes very frequently. For example, a retail store will always sell goods and this will be one of the core functions, but the way the retail store will sell the goods might differ with time and market needs, etc. These are the non core functions which change very frequently. In the software industry, it is desirable that the functions that change frequently should be decoupled from functions that change infrequently. In simplistic terms, SoA is the practice of segregating the core business functions into independent services that don't change frequently, and those that do. Going further it also extends this segregation to many things that can logically and functionally be separated, regardless of whether they're changeable or not. Service-oriented architecture (SOA) is an architectural style where existing or new functionalities are grouped into atomic services. These services communicate with each other by passing data from one service to another, or by coordinating an activity between one or more services.

A flexible, standardized architecture is required to better support the connection of various applications and the sharing of data. SOA, according to one exemplary embodiment of the present invention, is one such architecture. SOA unifies business processes by structuring large applications as an ad-hoc collection of smaller modules called services. These applications can be used by different groups of people and/or systems, in some cases, inside and/or outside the company, and new applications built from a mix of services from the global pool exhibit greater flexibility and uniformity. One should not, for example, have to provide redundantly the same personal information to multiple related applications, such as, e.g., patient information to an insurance application, a medical record system, and a patient check-in at an emergency room, and the interfaces one interacts with should have the same look and feel and use the same level and type of input data validation. Building all applications from the same pool of services makes achieving this goal much easier and more deployable to affiliate companies. Thus, according to one exemplary embodiment, an SoA architecture may be employed.

FIG. 3 depicts an exemplary diagram 300 illustrating an exemplary performance analytics system illustrating an exemplary interaction between exemplary modules and submodules of an exemplary healthcare services heuristic performance analytics system according to an exemplary embodiment of the present invention. An exemplary and non-limiting system 300 may include a nondeterministic health care services delivery data performance analytics engine 302, which in an exemplary embodiment, may include a data capture system 304, an expert system 306, a Bayesian inference engine 308, all of which may interface with a knowledgebase 314 via, e.g., but not limited to, a database management system 208c (not shown), according to an exemplary embodiment. The exemplary nondeterministic health care services delivery data performance analytics engine 302 may further analyze data to form recommendations and/or notifications via recommendation and notification system 310, which may provide interactive access to analyzed data to end users via a user interface 312, which in an exemplary embodiment may be a dashboard (see FIG. 14), which may be accessed by any healthcare entity 316, 102 such as, e.g., but not limited to, a health care provider.

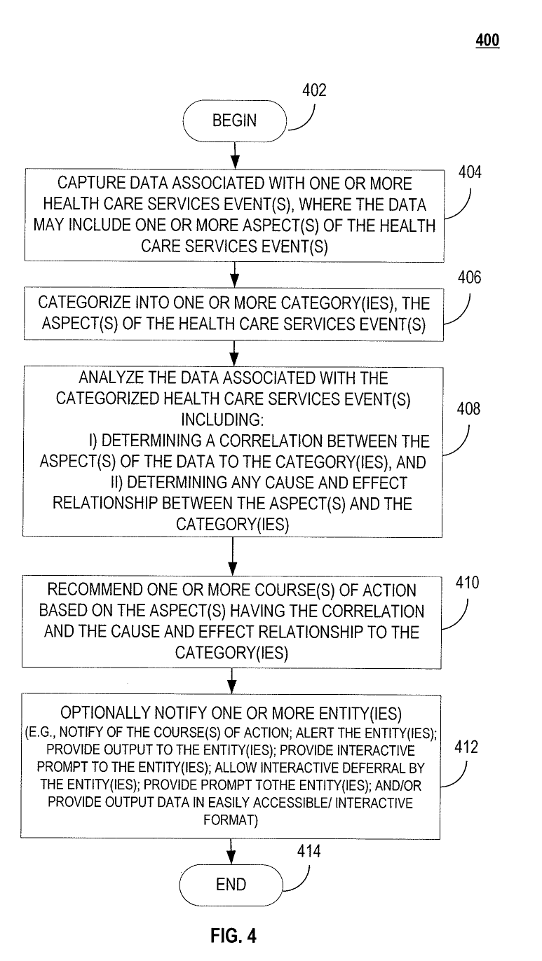

FIG. 4 depicts an exemplary diagram 400 illustrating a flow diagram of an exemplary performance analytic process illustrating an exemplary data collection, analysis and output method according to an exemplary embodiment of the present invention. According to an exemplary embodiment, an exemplary flow diagram 400 may begin with 402 and in an exemplary embodiment, may continue with 404.

In 404, data associated with one or more health care services events may be captured, where the data may include one or more aspects of the health care services events, according to an exemplary embodiment. From 404, flow diagram 400 may continue with 406.

In 406, aspects of the health care services event data may be categorized into one or more categories, according to an exemplary embodiment. From 406, flow diagram 400 may continue with 408.

In 408, the data associated with the categorized healthcare services events may be analyzed, which may include, in an exemplary embodiment, determining a correlation between aspects of the data to the categories, and determining any cause and effect relationships between the aspect and the category, according to an exemplary embodiment. From 408, flow diagram 400 may continue with 410.

In 410, recommendations may be created and provided regarding, e.g., but not limited to, one or more courses of action, based on the aspects having the correlation and cause and effect relationship to the categories, according to an exemplary embodiment. From 410, flow diagram 400 may continue with 412, or may immediately end with 414.

In 412, optionally, notifications may be created and provided regarding, e.g., but not limited to, one or more courses of action, based on the aspects having the correlation and cause and effect relationship to the categories, according to an exemplary embodiment. Various other notifications, alerts, interactive prompts, interactive deferrals (akin to a snooze button functionality), and/or other output format may be provided. From 412, flow diagram 400 may continue with and may immediately end with 414.

In 414, flow diagram 400 may immediately end, according to an exemplary embodiment.

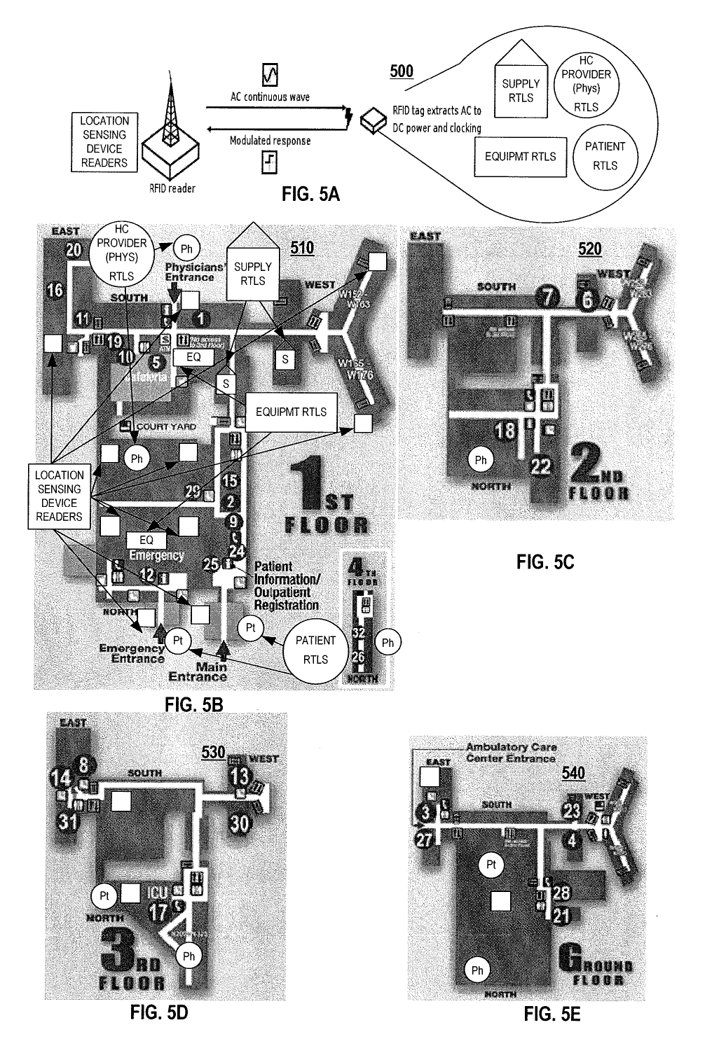

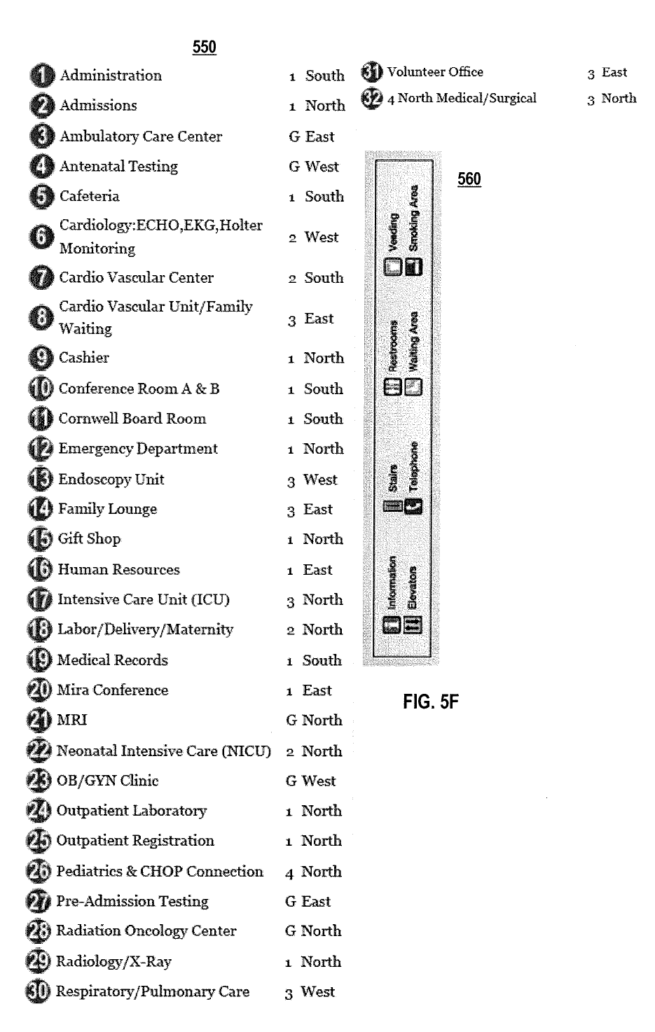

FIG. 5A depicts an exemplary diagram 500 illustrating an exemplary radio frequency identification (RFID) system illustrating an exemplary location based health care data collection device 208a, according to an exemplary embodiment of the present invention.

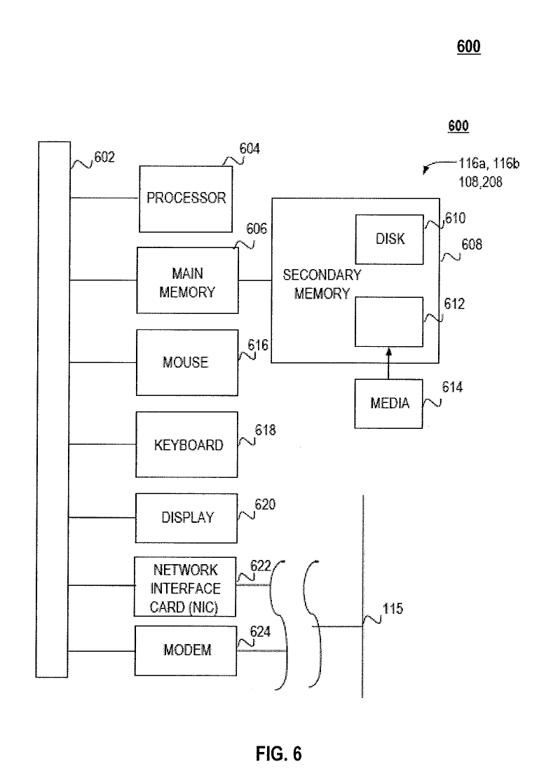

FIG. 6 depicts an exemplary diagram 600 illustrating an exemplary computer system according to an exemplary embodiment of exemplary components of a system that could be used as a client, server, network, and/or other component of the systems according to an exemplary embodiment of the present invention. See further discussion below.

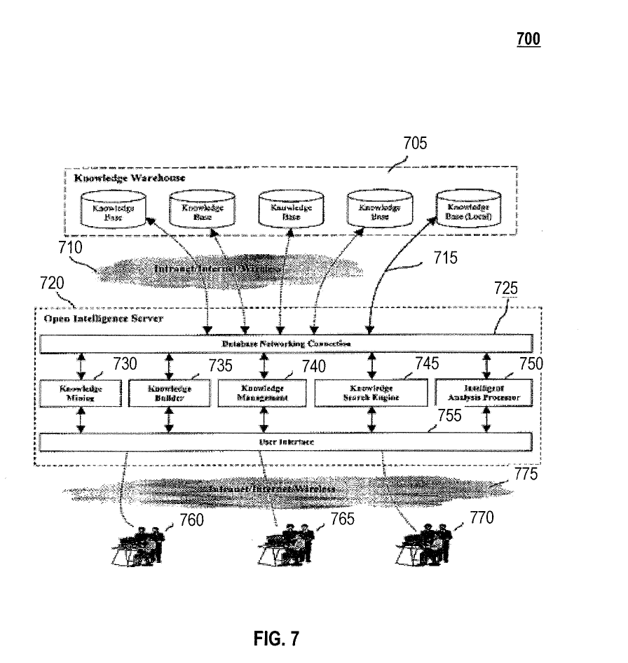

FIG. 7 depicts an exemplary diagram 700 illustrating an exemplary knowledge intelligence system illustrating an exemplary system which may be used as a subcomponent of a performance analytics health care data analysis system according to an exemplary embodiment of the present invention.

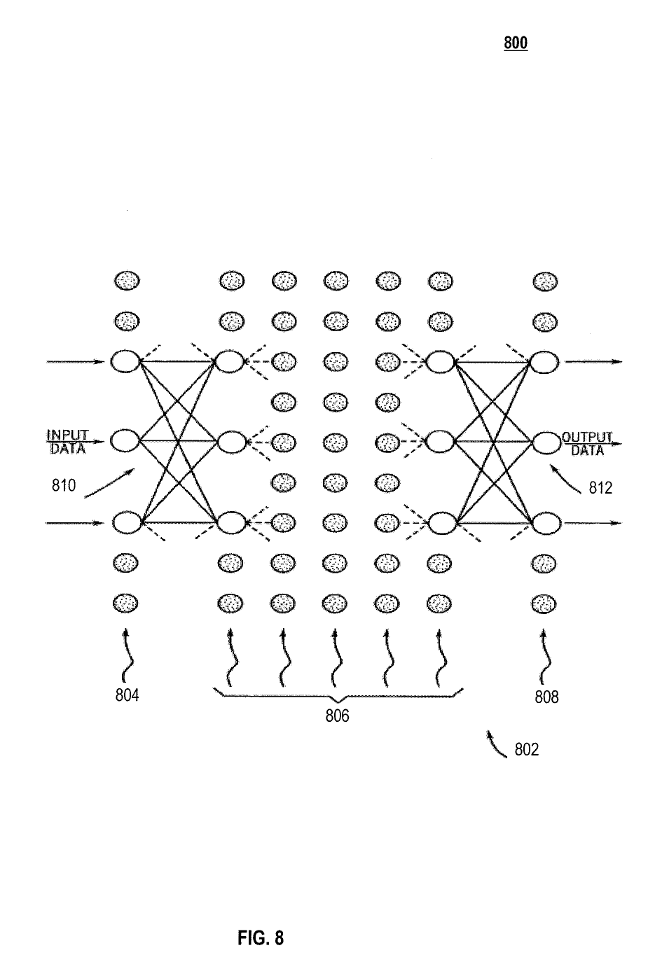

FIG. 8 depicts an exemplary diagram 800 illustrating an exemplary artificial neural network including a number of units and connections between them, implemented by hardware and/or software, and graphically represented as shown, according to an exemplary embodiment of the present invention.

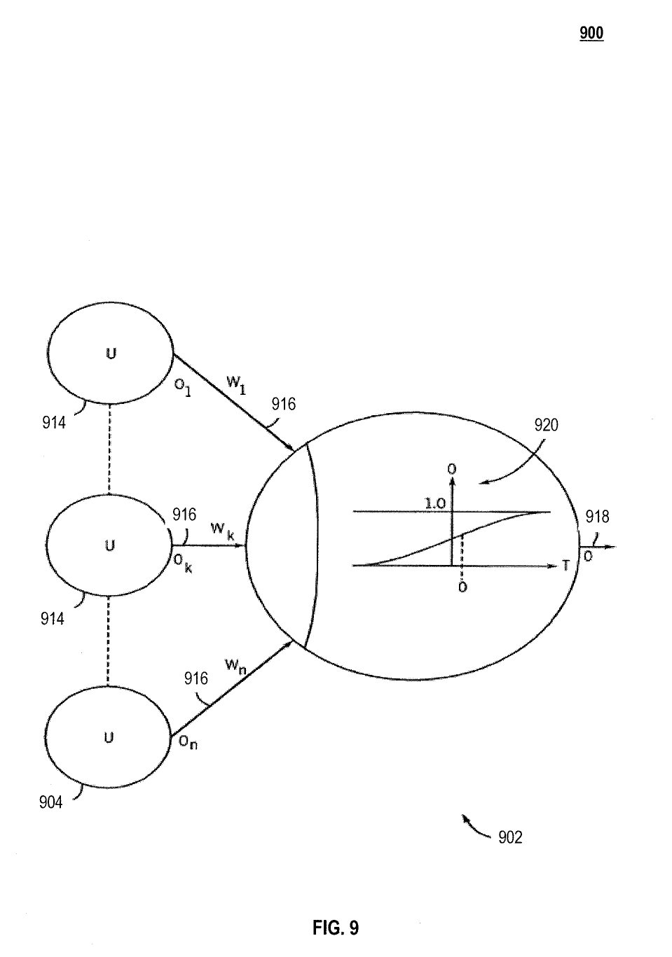

FIG. 9 depicts an exemplary diagram 900 illustrating an exemplary neural network, which may be implemented in hardware and/or software, according to an exemplary embodiment of the present invention.

### Exemplary Operating Room Embodiment

In one embodiment, the system may be utilized to optimize and/or maximize utilization of hospital operating rooms. The operating room, according to an exemplary embodiment, may be equipped with, e.g., but not limited to, a radio frequency identification (RFID) (or other auto-ID technology) reader at, e.g., the entrance, and/or another location proximate to the operating room, to allow tracking of RFID tags in the vicinity of the operating room (or other locations, rooms, etc. of import to health care service delivery provision). A hospital computer database may, e.g., store, e.g., a list of instruments needed for a particular operation, or other protocol/preference, etc. Instruments, according to an exemplary embodiment, may also be marked with, e.g., but not limited to, RFID tags, or some other location based tracking device. According to an exemplary embodiment, at thirty minutes (or whatever time, or another trigger that the hospital/health care facility has previously set as a checkpoint) before the scheduled start of the operation, an exemplary embodiment of the present invention might compare a location of, e.g., including but not limited to, all of the instruments identified in, or within a given proximity to, the operating room, related to the operation, with a list of needed instruments previously defined (or learned) in a preference. The system, according to an exemplary embodiment, may send a notification immediately (by, e.g., email or any other available method, e.g., which may be preferred by the healthcare service provider who is assigned to conduct the health care services event (e.g., operation)), to, e.g., a scrub nurse in charge of the given operating room, and/or, according to an exemplary embodiment, may also notify a hospital staff member responsible for, e.g., delivering the proper instruments to the operating room in time, identifying any missing instruments, and/or alerting the health care provider(s) that the operation may be scheduled to start in xx minutes, for example.

As a further example, the system, according to an exemplary embodiment of the present invention, may get “smarter” over time, by, e.g., but not limited to, increasing the interval time for the next similar operation based on, e.g., but not limited to, tracking and/or analyzing prior issues and/or problems. Also, e.g., but not limited to, a scrub nurse on duty on a particular morning, may be notified when the nurse first comes on shift, for example, that there may be an operation that morning for which there was a missing instrument problem during, e.g., the previous week for a similar operation.

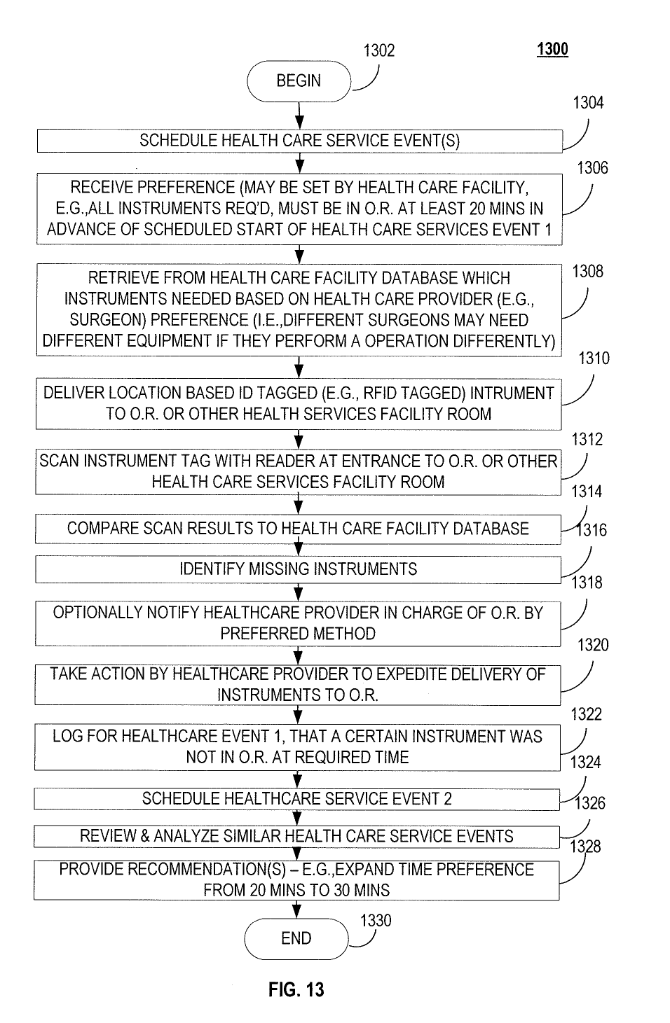

FIG. 13 depicts an exemplary healthcare services performance analytics service provider workflow according to an exemplary embodiment of the present invention. In FIG. 13, an exemplary flow diagram 1300, according to an exemplary embodiment of the present invention may illustrate an exemplary, but non-limiting, process flow for an exemplary health care service performance analytics process flow. Flow diagram 1300 may begin with 1302 and may continue immediately with 1304, according to an exemplary embodiment of the present invention.

In 1304, according to an exemplary embodiment of the present invention, a health care service event(s) may be scheduled. From 1304, flow diagram 1300 may continue with 1306.

In 1306, according to an exemplary embodiment of the present invention, a preference, or preferences (may be set by health care facility or other entity, e.g., all instruments require for an operation, must be in the operating room (O.R.) at least 20 minutes in advance of a scheduled start of the health care services event 1 may be received. From 1306, flow diagram 1300 may continue with 1308.

In 1308, according to an exemplary embodiment of the present invention, which instruments are needed may be retrieved from a health care facility database based on, e.g., but not limited to, a health care provider (e.g., surgeon, etc.) preference (i.e., different surgeons may need different equipment if they, e.g., but not limited to, perform an operation differently and/or use different techniques, etc.). From 1308, flow diagram 1300 may continue with 1310.

In 1310, according to an exemplary embodiment of the present invention, a location-based id tagged (e.g., RFID tagged, etc.) instrument may be delivered to the O.R. or other health services facility room, according to an exemplary embodiment. From 1310, flow diagram 1300 may continue with 1312.

In 1312, according to an exemplary embodiment of the present invention, the instrument tag of the instrument may be scanned by a reader at, e.g., an entrance to the O.R., as the instrument is, e.g., but not limited to, brought in proximity to the O.R., or other health care services facility room. From 1312, flow diagram 1300 may continue with 1314.

In 1314, according to an exemplary embodiment of the present invention, scan results may be compared to health care facility database. From 1314, flow diagram 1300 may continue with 1316.

In 1316, according to an exemplary embodiment of the present invention, missing instruments may be identified. From 1316, flow diagram 1300 may continue with 1318.

In 1318, according to an exemplary embodiment of the present invention, optionally, the healthcare provider, which may be in charge of O.R., or another entity, for example, may be notified that a missing instrument has been identified, and the notification may be provided by any preferred method. From 1318, flow diagram 1300 may continue with 1320.

In 1320, according to an exemplary embodiment of the present invention, the healthcare provider (or other person or entity), may take action to expedite delivery of the missing instrument/equipment/resource/etc. to the O.R. From 1320, flow diagram 1300 may continue with 1322.

In 1322, according to an exemplary embodiment of the present invention, for healthcare event 1, the fact that a certain instrument was not in O.R. at the required time may be logged, or such information may be stored, or may be analyzed for further processing, etc. From 1322, flow diagram 1300 may continue with 1324.

In 1324, according to an exemplary embodiment of the present invention, a healthcare service event 2 may be scheduled. From 1324, flow diagram 1300 may continue with 1326.

In 1326, according to an exemplary embodiment of the present invention, similar health care service events (such as events of similar description and/or of relatively similar completion time (e.g., operations of a particular type over the past month, etc.) may be reviewed and/or analyzed. As a result of such analysis, other processing may be performed, for example. From 1326, flow diagram 1300 may continue with 1328.

In 1328, according to an exemplary embodiment of the present invention, the analysis or processing of 1326 might result in a recommendation or recommendations which may be provided to the entities such as, e.g., but not limited to, revising preferences for health care services providers, or the health care facility, etc., (e.g., it could be recommended that the time preference be expanded from 20 minutes to 30 minutes. From 1328, flow diagram 1300 may continue with 1330.

In one exemplary embodiment, flow diagram 1300 may end at 1330.

According to one exemplary embodiment, a recommendation and/or notification may be provided via an output device. In one exemplary embodiment, an output device may include a dashboard.

FIG. 14 depicts an exemplary dashboard 1400 diagram, which in an exemplary embodiment may include a graphical user interface 1402, which may include operational protocols and/or procedural preferences which may be attributable to the health care facility and/or health care worker and/or provider. For a given procedure 1, 2, or 3, a graphical indication of progress through the health care event may be provided to the health care worker, such as a graphical progress bar 1406, a visual indicator of progress milestones, such as a light, or blinking color indicator 1404, as shown, a timeline, a clock, an analog timer (not shown), a digital representation of a time quantity 1408, an audio indication (not shown), which may be varied using, e.g., an adjuster 1410, and/or a snooze delay interface capability 1410. In another exemplary embodiment, the device may include voice recognition and/or interactive, secure, voice command technology to manipulate prompts, alerts, messages, notifications, suggestions, recommendations, etc.

In another exemplary embodiment of the present invention, the system can also be used when doctors are scheduling an operating room. For example, a doctor may schedule the O.R. for, e.g., a 2 hours hip replacement operation. However, suppose that the system, according to an exemplary embodiment, may “know,” from its knowledgebase for example, that over the last x number of days, for example, that the doctor has done y number of hip replacement operations (or other procedures/events) and that the shortest duration was, e.g., 3 hours. Thus the system, according to one exemplary embodiment, may block out, e.g., 3 hours of time, or might recommend, or prompt a reservation of 3 hours of time for the operation. Various other exemplary embodiments along such lines may also be provided in other alternative processes.

### Other Exemplary Embodiments

An exemplary embodiment of the present invention, can be used in, e.g., but not limited to, any area of a health care service facility, as shown for example in FIGS. 5A-5F, reference numerals 500-560, including, e.g., but not limited to:
1) operating room utilization improvement;
2) emergency department utilization improvement;
3) nursing station(s) service delivery, to improve, e.g., nurse workloads based on, e.g., patient acuity, or otherwise;
4) patient rooms service delivery improvement, to improve, e.g., ensuring that, e.g., but not limited to, that the proper equipment may be deployed;
5) ancillary services service delivery improvement, for improving service delivery by, e.g., but not limited to, tracking locations such as, e.g., or not limited to, Physical Therapy, Occupational Therapy, etc., to improve, e.g., but not limited to, service levels, measure effectiveness and/or ensure that orders have been executed accurately and timely;
6) diagnostic departments service delivery improvement, for departments such as, e.g., but not limited to, radiology, pharmacy and/or laboratory for improving, e.g., but not limited to, patient movement, and/or equipment/room/resource utilization, etc.;
7) biomedical engineering service delivery improvement, for improving, e.g., but not limited to, effective and/or timely use of equipment, supplies, pumps, devices and/or other expensive and/or scarce equipment, etc.; and/or
8) transport services service delivery improvement, for improving, e.g., but not limited to, service by providing more effective patient movement, e.g., but not limited to, among and/or between, locations, etc., where medical services, entities, and/or equipment may be delivered.

### Location-Based Tracking Systems

According to an exemplary embodiment, location-based tracking systems 208a may be used to track the location of, e.g., but not limited to, patients, physicians, care providers, equipment, supplies, etc. Any of various location detection technologies may be used according to an exemplary embodiment.

According to an exemplary embodiment, location based tracking devices may be used to track people, health care service provider personnel, health care resources, supplies, and/or locations and/or relative proximity, and/or duration of a particular proximity, and/or location, of people and things.

According to an exemplary embodiment, location based tracking devices may include a global positioning system (GPS), or other location tracking system.

According to an exemplary embodiment, location based tracking devices may include any form of radio frequency based system.

According to an exemplary embodiment, location based tracking devices may include a radar-based technology, such as, e.g., but not limited to, a Radianse based system, available from Radianse, Inc. of Andover, Mass. According to one exemplary embodiment, an active RFID system may be used. According to another exemplary embodiment, a wireless communications technology may be used such as, e.g., but not limited to, RF, WI-FI, WI-MAX, Ultrawideband (UWB), Microwave, satellite, non-interfering technologies, IEEE 802.11, IEEE 802.16, 802.x, tracking technology, tracing technology, track and trace technology, etc.

In various additional exemplary embodiments, a manual and/or automatic location-based tracking technology may be used, such as, e.g., a barcode and/or barcode reader, a two dimensional, three dimensional, or more dimensional barcode, any location tracking device that may require human intervention, and technologies which are automatic, and do not require any human intervention.

According to one exemplary embodiment a Passive, an Active, and/or a semi-active radio frequency (RF), or other wireless location identifying device may be used.

### Radio Frequency Identifier (RFID)

Radio-frequency identification (RFID) may be an exemplary automatic identification method, relying on storing and remotely retrieving data using devices called RFID tags or transponders.

An RFID tag may include an object that can be applied to or incorporated into a product, supply, equipment, patient, health care provider, health care worker, physician, supplies, equipment, resources, and/or person(s), etc. for the purpose of identification using radiowaves. Some tags can be read from several meters away and beyond the line of sight of the reader.

Most RFID tags contain at least two parts. One may be an integrated circuit for storing and processing information, modulating and demodulating a (RF) signal and can also be used for other specialized functions. The second may include an antenna for receiving and transmitting the signal. A technology called chipless RFID may allow for discrete identification of tags without an integrated circuit, thereby allowing tags to be printed directly onto assets at lower cost than traditional tags.

A significant thrust in RFID use has conventionally been in enterprise supply chain management, improving the efficiency of inventory tracking and management.

RFID tags come in three general varieties: passive, active, or semi-passive (also known as battery-assisted). Passive tags may require no internal power source, thus being pure passive devices (they may be only active when a reader may be nearby, in proximity to power them), whereas semi-passive and active tags may require a power source, usually a small battery.

RFID backscatter may be used to manipulate a reader's field. FIG. 5A depicts an exemplary illustration 500 of an RFID tag coming into proximity to a reader, and, extracting AC to DC power and clocking from an AC continuous wave transmitted by the RFID reader to the RFID tag, and generating by the RFID tag, according to an exemplary embodiment, a modulated response, so as to identify the location of the RFID tag within a given proximity to the reader. To communicate, tags may respond to queries generating signals that must not create interference with the reader's, as arriving signals can be very weak and must be told apart. Typically, backscatter may be used in the far field, whereas load modulation may apply in the near field to manipulate the reader's field, within a few wavelengths from the reader.

FIGS. 5B, 5C, 5D, 5E and 5F depict floorplan and legend diagrams 510, 520, 530, 540, and 550, respectively, which in combination, illustrate an exemplary depiction of a health care facility environment, depicting various entities including health care service provider entities such as, e.g., but not limited to, physicians, nurses, surgeons, clinicians, technicians, transport, therapists, etc., as well as equipment and supplies, all outfitted with a real time location system (RTLS) device, or other location based sensing device, as well as location based system device readers such as, e.g., but not limited to, RFID readers, for identifying the location of one of these devices.

### Passive

Passive RFID tags have generally have no internal power supply. The minute electrical current induced in the antenna by the incoming radio frequency signal provides just enough power for the, e.g., CMOS integrated circuit in the tag to power up and transmit a response. Most passive tags signal by backscattering the carrier wave from the reader. This means that the antenna has to be designed to both collect power from the incoming signal and also to transmit the outbound backscatter signal. The response of a passive RFID tag may be not necessarily just an ID number; the tag chip can contain, e.g., non-volatile, possibly writable EEPROM for storing data.

Passive tags may have practical read distances ranging from about 10 cm (4 in.) (ISO 14443) up to a few meters (Electronic Product Code (EPC) and ISO 18000-6), depending on the chosen radio frequency and antenna design/size. Due to their simplicity in design they may be also suitable for manufacture with a printing process for the antennas. The lack of an onboard power supply means that the passive device can be quite small: commercially available products exist that can be embedded in a sticker, or under the skin in the case of low frequency RFID tags.

In 2006, Hitachi, Ltd. of Tokyo, Japan, developed a passive device called the μ-Chip measuring 0.15×0.15 mm (not including the antenna), and thinner than a sheet of paper (7.5 micrometers). Silicon-on-Insulator (SOI) technology may be used to achieve this level of integration. The Hitachi μ-Chip, e.g., can wirelessly transmit a 128-bit unique ID number which may be hard coded into the chip as part of the manufacturing process. The unique ID in the chip cannot be altered, providing a high level of authenticity to the chip and ultimately to the items the chip may be permanently attached or embedded into. The Hitachi μ-Chip has a typical maximum read range of 30 cm (1 foot). In February 2007 Hitachi unveiled an even smaller RFID device measuring 0.05×0.05 mm, and thin enough to be embedded in a sheet of paper. The new chips can store as much data as the older μ-chips, and the data contained on them can be extracted from as far away as a few hundred meters. The ongoing problem with all RFIDs may be that they need an external antenna which may be 80 times bigger than the chip in the best version thus far developed.

Alien Technology's Fluidic Self Assembly, SmartCode's Flexible Area Synchronized Transfer (FAST) and Symbol Technologies' PICA process may be believed to potentially further reduce tag costs by massively parallel production. Alien Technology and SmartCode may be currently using the processes to manufacture tags. Alternative methods of production such as, e.g., or not limited to, FAST, FSA and PICA could potentially reduce tag costs dramatically, and due to volume capacities achievable, in turn be able to also drive the economies of scale models for various Silicon fabricators as well. Some passive RFID vendors believe that Industry benchmarks for tag costs can be achieved eventually as new low cost volume production systems may be implemented more broadly.

Non-silicon tags made from polymer semiconductors may be currently being developed by several companies globally. Simple laboratory printed polymer tags operating at 13.56 MHz were demonstrated in 2005 by both PolyIC (Germany) and Philips (The Netherlands). Polymer tags may be roll-printable, like a magazine, and may be less expensive than silicon-based tags. Eventually, item-level tagging may include RFID tags which may be wholly printed—the same way a barcode may be today—and be virtually free, like a barcode. Silicon processing, with per-feature cost which may be less than that of conventional printing may also be used.

### Active

Unlike passive RFID tags, active RFID tags may have their own internal power source, which may be used to power the integrated circuits and broadcast the signal to the reader. Active tags may be typically much more reliable (e.g. fewer errors) than passive tags due to the ability for active tags to conduct or maintain a “session” with a reader. Active tags, due to their onboard power supply, may also transmit at higher power levels than passive tags, allowing them to be more effective in “RF challenged” environments like water (including, e.g., humans/cattle/other animals, which are often mostly water), metal (shipping containers, vehicles), or at longer distances, generating strong responses from weak requests (as opposed to passive tags, which work the other way around). In turn, they may be generally bigger and more expensive to manufacture, and their potential shelf life may be much shorter.

Many active tags today have practical ranges of hundreds of meters, and a battery life of up to 10 years. Some active RFID tags include sensors such as, e.g., or not limited to, temperature logging which have been used to monitor the temperature of perishable goods like fresh produce or certain pharmaceutical products. Other sensors that have been married with active RFID include humidity, shock/vibration, light, radiation, temperature, and atmospherics like ethylene. Active tags typically have a much longer range (such as, e.g., approximately 500 m/1500 feet) and larger memories than passive tags, as well as the ability to store additional information sent by the transceiver. The United States Department of Defense has successfully used active tags to reduce logistics costs and improve supply chain visibility for more than 15 years.

### Semi-Passive

Semi-passive tags may be similar to active tags as they have their own power source, but the battery may be used just to power the microchip and not broadcast a signal. The RF energy may be reflected back to the reader like a passive tag. An alternative use for the battery may be to store energy from the reader to emit a response in the future, usually by means of backscattering. Tags which do not have a battery may need to emit their response reflecting energy from the reader carrier on the fly.

Semi-passive tags may be comparable to active tags in reliability while featuring the effective reading range of a passive tag. They usually last longer than active tags as well.

### Antenna Types

The antenna used for an RFID tag may be affected by the intended application and the frequency of operation. Low-frequency (LF) passive tags may be normally inductively coupled, and because the voltage induced may be proportional to frequency, many coil turns may be needed to produce enough voltage to operate an integrated circuit. Compact LF tags, like glass-encapsulated tags used in animal and human identification, may use a multilayer coil (3 layers of 100-150 turns each) wrapped around a ferrite core.

At 13.56 MHz (High frequency or HF), a planar spiral with 5-7 turns over a credit-card-sized form factor can be used to provide ranges of tens of centimeters. These coils may be less costly to produce than LF coils, since they can be made using lithographic techniques rather than by wire winding, but two metal layers and an insulator layer may be needed to allow for the crossover connection from the outermost layer to the inside of the spiral where the integrated circuit and resonance capacitor may be located.

Ultra-high frequency (UHF) and microwave passive tags may be usually radiatively-coupled to the reader antenna and can employ conventional dipole-like antennas. Only one metal layer may be required, reducing cost of manufacturing. Dipole antennas, however, may be a poor match to the high and slightly capacitive input impedance of a typical integrated circuit. Folded dipoles, or short loops acting as inductive matching structures, may be often employed to improve power delivery to the IC. Half-wave dipoles (16 cm at 900 MHz) may be too big for many applications; for example, tags embedded in labels may be less than 100 mm (4 inches) in extent. To reduce the length of the antenna, antennas can be bent or meandered, and capacitive tip-loading or bowtie-like broadband structures may be also used. Compact antennas usually have gain less than that of a dipole—that is, less than 2 dBi—and can be regarded as isotropic in the plane perpendicular to their axis.

Dipoles may couple to radiation polarized along their axes, so the visibility of a tag with a simple dipole-like antenna may be orientation-dependent. Tags with two orthogonal or nearly-orthogonal antennas, often known as dual-dipole tags, may be much less dependent on orientation and polarization of the reader antenna, but may be larger and more expensive than single-dipole tags.

Patch antennas may be used to provide service in close proximity to metal surfaces, but a structure with good bandwidth may be, e.g., but not limited to, 3-6 mm thick, and the need to provide a ground layer and ground connection may increase cost relative to simpler single-layer structures.

HF and UHF tag antennas may be usually fabricated from copper or aluminum. Conductive inks have seen some use in tag antennas but have encountered problems with IC adhesion and environmental stability.

### Tag Attachment

Basically, there may be three different kinds of RFID tags based on their attachment with identified objects, i.e. attachable, implantable and insertion tags. In addition to these conventional RFID tags, Eastman Kodak Company of Rochester, N.Y. has technology, e.g., for monitoring ingestion of medicine including forming a digestible RFID tag.

### Tagging Positions

RFID tagging positions can influence the performance of air interface UHF RFID passive tags and related to the position where RFID tags may be embedded, attached, injected or digested.

In many cases, optimum power from RFID reader may be not required to operate passive tags. However, in cases where the Effective Radiated Power (ERP) level and distance between reader and tags may be fixed, such as, e.g., or not limited to, in manufacturing setting, it may be important to know the location in a tagged object where a passive tag can operate optimally.

R-Spot or Resonance Spot, L-Spot or Live Spot and D-Spot or Dead Spot may be defined to specify the location of RFID tags in a tagged object, where the tags can still receive power from a reader within specified ERP level and distance.

### Tag Environments

The proposed ubiquity of RFID tags means that readers may need to select which tags to read among many potential candidates, or may wish to probe surrounding devices to perform inventory checks or, in case the tags may be associated to sensors and capable of keeping their values, question them for environmental conditions. If a reader intends to work with a collection of tags, it may need to either discover all devices within an area to iterate over them afterwards, or use collision avoidance protocols.

In order to read tag data, readers may use a tree-walking singulation algorithm, resolving possible collisions and processing responses one by one. Blocker tags may be used to prevent readers from accessing tags within an area without killing surrounding tags by means of suicide commands. These tags may masquerade as valid tags but may have some special properties: in particular, they may possess any identification code, and may deterministically respond to all reader queries, thus rendering them useless and securing the environment.

Tags may also be promiscuous, i.e., attending all requests alike, or secure, which may require authentication and control of typical password management and secure key distribution issues. A tag may as well be prepared to be activated or deactivated in response to specific reader commands.

Readers that may be in charge of the tags of an area may operate in autonomous mode (as opposed to interactive mode). When in this mode, a reader may periodically, or otherwise locate all tags in its operating range, and may keep a presence list with a persist time and some control information. When an entry expires, it may be removed from the list.

Frequently, a distributed application may require both types of tags. Since passive tags may be incapable of continuous monitoring and performing tasks on demand when accessed by readers, they may be useful when activities may be regular and well defined, and requirements for data storage and security may be limited; when accesses may be frequent, continuous or unpredictable, where there may be time constraints to meet or data processing (internal searches, for instance) to perform, then active tags may be preferred for such applications.

Although, the present application is directed to a human health care services environment, another exemplary embodiment of Applicant's invention could be used in an animal hospital (indeed although the exemplary embodiments are described with reference to health care service delivery, this technology is equally relevant to health care service delivery to other mammals and other types of animals, such as, e.g., but not limited to, veterinarian care-large or small animal, as well as zoological care).

### Knowledge Base

Knowledge bases (KBs) 314 may be included in one exemplary embodiment of the health care services performance analytics system 302. KBs 314 may be categorized into two major types:

1) Machine-readable knowledge bases 314—may store knowledge in a computer-readable form, usually for the purpose of having automated deductive reasoning applied to them. Machine-readable knowledge bases 314 may contain a set of data, often in the form of rules that may describe the knowledge in a logically consistent manner. Logical operators such as, e.g., or not limited to, And (conjunction), Or (disjunction), material implication and negation may be used to build the knowledge base up from the atomic knowledge. Consequently classical deduction can be used to reason about the knowledge in the knowledge base.

2) Human-readable knowledge bases 314—may be designed to allow people to retrieve and use the knowledge that the knowledge bases contain, primarily for training purposes. Human-readable knowledge bases 314 may be commonly used to capture explicit knowledge of an organization, including troubleshooting, articles, white papers, user manuals and others. The primary benefit of such a knowledge base may be to provide a means to discover solutions to problems that have known solutions which can be re-applied by others, less experienced in the problem area.

The most important aspect of a knowledge base 314 may be the quality of information it contains. The best knowledge bases 314 have carefully written information and/or rules that may be kept up to date, an excellent information retrieval system (search engine), and a carefully designed content format and classification structure.

A knowledge base may use an ontology to specify its structure (entity types and relationships) and the knowledge base's 314 classification scheme. An ontology, together with a set of instances of the knowledge base's classes may constitute a knowledge base 314.

Determining what type of information may be captured, and where that information resides in a knowledge base 314 may be something that may be determined by the processes that support the system. A robust process structure may be the backbone of any successful knowledge base 314.

Some knowledge bases 314 have an artificial intelligence component. These kinds of knowledge bases 314 can suggest solutions to problems sometimes based on feedback provided by the user, and may be capable of learning from experience (i.e., an expert system). Knowledge representation, automated reasoning and argumentation may be areas of research at the forefront of artificial intelligence.

Human analytical logic or reasoning processes can be represented by a (decision or knowledge) tree structure. Because of a unique tree's characteristics such as, e.g., or not limited to, independency of peer nodes and a single parent node, the tree structure may be a most scalable, flexible, and commonly used analytical structure. Although many decision-tree construction methods (e.g. Naive-Bayes, Classification, Fuzzy, and Neural Network) have been developed, the structures of nodes may be often not uniform. Different decision-tree construction methods may use different node structures. Even within the same construction method, sometimes, many different node structures (e.g. decision node, classifier node, data/factor node) may be used. Various systems may be used, for a decision tree with multiple node structures, the analysis process, logic modification, and logic sharing (e.g. embedding a decision tree into another decision tree that may be built with a different construction method may be desirable).

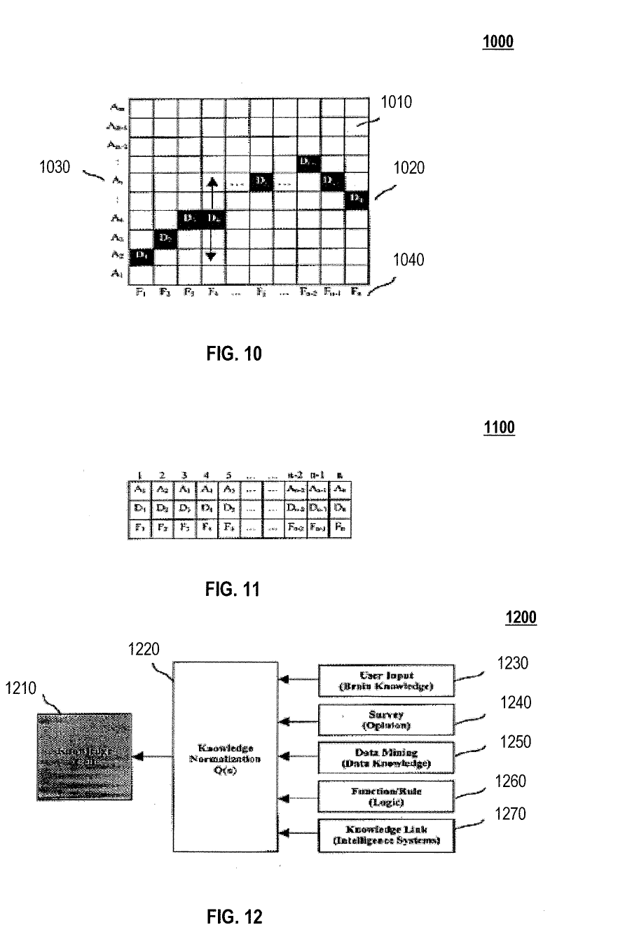

FIG. 10 shows an open knowledge cell structure 1000 in accordance with one exemplary but non-limiting embodiment of the present invention. The open knowledge cell structure 1000 includes a (m×n) matrix 1010, decision functions Dⱼ (=1,2, . . . , n) 1020, action functions Aᵢ (i=1,2, . . . , m) 1030 and factors Fⱼ (=1,2, . . . , n) 1040.

Each column of the matrix 1010 may have only one decision function value that may be generated by the corresponding decision function Dⱼ 1020. The value of the decision function Dⱼ 1020 indicates which action function Aᵢ (i=1,2, . . . , m) 1030 will be used or executed. Each column Fⱼ of the knowledge cell 100 may have one and only one decision function Dⱼ 1020. The action functions, Aᵢ (i=1,2, . . . , m) 1030, may be usually arranged in a specific order (e.g. Aᵢ may be an action function for the worst case or the most pessimistic decision and Aₘ may be an action function for the best case or the most optimistic decision. The functions may be in an order from the worst to the best). The value of the decision function Dⱼ 1020 can be constant value or generated by a user specified function. The action function Aᵢ 1030 can be a constant value (e.g. a decision or forecasting message), a user specified function, a user specified function link (e.g. an analysis report link or function call), or a user specified control command (e.g. an event trigger or control signal). The factor Fⱼ 1040 can be a constant value, a user specified function, or user specified function link (e.g. a factor range generator). When using function links, the values of the knowledge cell 1000 may be dynamic, which may enable the intelligent analysis process to always use the latest knowledge.

FIG. 11 shows an example of storing a (n×n) knowledge cell that may use a (3×n) unit storage space, where each value of the decision function Dⱼ may determine which action function Aᵢ to be used for a factor Fⱼ.

FIG. 12 depicts an exemplary knowledge-mining method 1200 in accordance with one exemplary embodiment of the present invention. The knowledge-mining process, according to one exemplary embodiment, may include a knowledge cell 1210, a user specified knowledge normalization function 1220 and a knowledge collecting method 1230, 1240, 1250, 1260, and/or 1270.

The knowledge-mining method 1200, according to one exemplary embodiment, can create or update a knowledge cell 1210 that is defined, according to one exemplary embodiment in FIG. 10. The knowledge-collecting function 1230, according to one exemplary embodiment, may provide an input interface for users to enter or define action, decision and/or factor range values manually, and/or otherwise. The knowledge-collecting methods 1240 and/or 1250 may provide an interface and functions for users to define and/or link survey and/or data mining methods to generate knowledge cell values. The knowledge-collecting methods 1260 and/or 1270 may provide functions for users to link existing analytic modules (e.g. knowledge trees) and/or analytic applications as knowledge cell values. The knowledge-normalization module 1220 may map collected actions, decisions, factor values into range 1 . . . m or 1 . . . n.

FIG. 7 depicts an exemplary embodiment of an open knowledge computer system 700 where a knowledge tree has been constructed, stored, shared, managed, and processed. Specifically, the open knowledge computer system 700 may include, in an exemplary embodiment, a knowledge warehouse 705 and an open intelligence server 720. Furthermore, the open intelligence server 720 may include a database networking connection function library 725, a knowledge mining tool 730, a knowledge builder 735, a knowledge management unit 740, a knowledge search engine 745, an intelligent analysis processor 750, and a user interface 755, according to an exemplary embodiment of the invention.

The knowledge warehouse 705, according to one exemplary embodiment, may be a set of virtually and/or physically linked knowledge bases 304 that may be built on the same, and/or different commercial databases such as, e.g., but not limited to, Oracle, MS SQL Server, Sybase, IBM DB2 and/or MS Access, etc. The open intelligence server 720 can access knowledge bases 705 remotely through network 710 or locally 715 through an I/O data bus where the knowledge base resides locally on the open intelligence server 720. Users 760-770 can perform knowledge construction, intelligence analysis and/or knowledge management through the user interface 755 and network 775.

In summary, an exemplary embodiment of the present invention may include an open knowledge structure, a method to construct an open knowledge node, and a method to construct an analysis module or knowledge tree with open and dynamic knowledge tree architecture, called open knowledge tree. Furthermore, an exemplary embodiment of the present invention may include a method of building an open knowledge computer system for knowledge mining, knowledge learning, analysis processing, and knowledge management.

### Artificial Intelligence and Neural Networks

A general diagrammatical representation of an artificial neural network as may be used in an exemplary embodiment of the present invention is illustrated in FIG. 8 and is designated by the reference numeral 802. Artificial neural networks may include of a number of units and connections between them, and can be implemented by hardware and/or software. The units of the neural network may generally be categorized into three types of different groups (layers), according to their functions, as illustrated in FIG. 8. A first layer, input layer 804, may be assigned to accept a set of data representing an input pattern, a second layer, output layer 808, may be assigned to provide a set of data representing an output pattern, and an arbitrary number of intermediate layers, hidden layers 806, and may convert the input pattern to the output pattern. Because the number of units in each layer may be determined arbitrarily, the input layer and the output layer may include sufficient numbers of units to represent the input patterns and output patterns, respectively, of a problem to be solved. Neural networks have been used to implement computational methods that learn to distinguish between objects or classes of events. The networks may be first trained by presentation of known data about objects or classes of events, and then may be applied to distinguish between unknown objects or classes of events.

Briefly, the principle of neural network 802 can be explained in the following manner. Normalized input data 810, which may be represented by numbers ranging from 0 to 1, may be supplied to input units of the neural network. Next, the output data 812 may be provided from output units through two successive nonlinear calculations (in a case of one hidden layer 806) in the hidden and output layers 808, 810. The calculation at each unit in the layer, excluding the input units, may include a weighted summation of all entry numbers, an addition of certain offset terms and a conversion into a number ranging from 0 to 1 typically using a sigmoid-shape function. In particular, as represented diagrammatically in FIG. 9, units 914, which may be labeled O1 to On, represent input or hidden units, W1 through Wn may represent the weighting factors 916 assigned to each respective output from these input or hidden units, and T may represent the summation of the outputs multiplied by the respective weighting factors. An output 918, or O may be calculated using the sigmoid function 920 given where Θ may represent an offset value for T. An example sigmoid function may be given by the following expression: 1/[1+exp(−T+Θ)]. The weighting factors and offset values may be internal parameters of the neural network 902, which may be determined for a given set of input and output data.

Two different basic processes may be involved in the neural network 902, namely, a training process and a testing process. The neural network may be trained by a back-propagation algorithm using pairs of training input data and desired output data. The internal parameters of the neural network may be adjusted to minimize the difference between the actual outputs of the neural network and the desired outputs. By iteration of this procedure in a random sequence for the same set of input and output data, the neural network learns a relationship between the training input data and the desired output data. Once trained sufficiently, the neural network can distinguish different input data according to its learning experience.

### Expert Systems

An exemplary embodiment of the health care services performance analytics service provider system 302, according to an exemplary embodiment of the present invention, may include an expert system 306, 208e. One of the results of research in the area of artificial intelligence (AI) has been the development of techniques which allow the modeling of information at higher levels of abstraction. These techniques may be embodied in languages or tools, which may allow programs to be built to closely resemble human logic in their implementation and may be therefore easier to develop and maintain. These programs, which emulate human expertise in well-defined problem domains, may be generally called expert systems.

The component of the expert system 306 that applies the knowledge to the problem may be called the inference engine, such as, e.g., but not limited to, a Bayesian inference engine 308. Four basic control components may be generally identified in an inference engine, namely, matching (comparing current rules to given patterns), selection (choosing most appropriate rule), implementation (implementation of the best rule), and execution (executing resulting actions).

To build an expert system 306 that may solve problems in a given domain, a knowledge engineer, an expert in Al language and representation, may read domain-related literature to become familiar with the issues and the terminology. With that as a foundation, the knowledge engineer then may hold extensive interviews with one or more domain experts to “acquire” their knowledge. Finally, the knowledge engineer may organize results of the interviews and may translate them into software that a computer can use.

Rule-based programming may be one of the most commonly used techniques for developing expert systems 306. Other techniques include fuzzy expert systems, which use a collection of fuzzy membership functions and rules, rather than Boolean logic, to reason relationships between data. In rule-based programming paradigms, rules may be used to represent heuristics, or “rules of thumb,” which may specify a set of actions to be performed for a given situation. A rule may be composed of an “if” portion and a “then” portion. The “if” portion of a rule may be a series of patterns which may specify the facts (or data) which may cause the rule to be applicable. The process of matching facts to patterns may be called pattern matching.

The expert system tool may provide an inference engine, which may automatically match facts against patterns and may select the most appropriate rule. The “if” portion of a rule can actually be thought of as a “whenever” portion of a rule, because pattern matching may occur whenever changes may be made to facts. The “then” portion of a rule may be the set of actions to be implemented when the rule may be applicable. The actions of applicable rules may be executed when the inference engine may be instructed to begin execution. The inference engine may select a rule, and then actions of the selected rule may be executed (which may affect the list of applicable rules by adding or removing facts). The inference engine may select another rule and may execute the other rule's actions. This process may continue until no applicable rules remain.

### Bayesian Inference

Bayesian inference 308, as used in an exemplary embodiment of the present invention, may use aspects of the scientific method, which may involve collecting evidence that may be meant to be consistent or inconsistent with a given hypothesis. As evidence accumulates, the degree of belief in a hypothesis may change. With enough evidence, the degree of belief may often become very high or very low. Thus, proponents of Bayesian inference say that Bayesian inference can be used to discriminate between conflicting hypotheses: hypotheses with a very high degree of belief should be accepted as true and those with a very low degree of belief should be rejected as false. However, detractors of Bayesian inference say that this inference method may be biased due to initial beliefs that one needs to hold before any evidence may be ever collected.

An example of Bayesian inference is “For billions of years, the sun has risen after it has set. The sun has set tonight. With very high probability (or ‘I strongly believe that’ or ‘it is true that’) the sun will rise tomorrow. With very low probability (or ‘I do not at all believe that’ or ‘it is false that’) the sun will not rise tomorrow.”

Bayesian inference may use a numerical estimate of the degree of belief in a hypothesis before evidence has been observed and may calculate a numerical estimate of the degree of belief in the hypothesis after evidence has been observed. Bayesian inference usually relies on degrees of belief, or subjective probabilities, in the induction process and does not necessarily claim to provide an objective method of induction. Nonetheless, some Bayesian statisticians believe probabilities can have an objective value and therefore Bayesian inference can provide an objective method of induction. Bayes' theorem may adjust probabilities given new evidence in the following way:

$$P ( {H}_{0} \vert E ) = \frac{P ( E \vert {H}_{0} ) P ( {H}_{0} )}{P ( E )}$$

where
H0 represents a hypothesis, called a null hypothesis, that was inferred before new evidence, E, became available.
P(H0) may be called the prior probability of H0.
P(E\H0) may be called the conditional probability of seeing the evidence E given that the hypothesis H0 is true. It may be also called the likelihood function when it is expressed as a function of H0 given E.
P(E) may be called the marginal probability of E: the probability of witnessing the new evidence E under all mutually exclusive hypotheses. It can be calculated as the sum of the product of all probabilities of mutually exclusive hypotheses and corresponding conditional probabilities: ΣP(E\Hᵢ)P(Hᵢ)
P(H0\E) may be called the posterior probability of H0 given E.

The factor P(E\H₀)/P(E) represents the impact that the evidence has on the belief in the hypothesis. If it is likely that the evidence will be observed when the hypothesis under consideration is true, then this factor will be large. Multiplying the prior probability of the hypothesis by this factor would result in a large posterior probability of the hypothesis given the evidence. Under Bayesian inference, Bayes' theorem therefore measures how much new evidence should alter a belief in a hypothesis.

Bayesian statisticians argue that even when people have very different prior subjective probabilities, new evidence from repeated observations will tend to bring their posterior subjective probabilities closer together. However, others argue that when people hold widely different prior subjective probabilities their posterior subjective probabilities may never converge even with repeated collection of evidence. These critics argue that worldviews which may be completely different initially can remain completely different over time despite a large accumulation of evidence.

Multiplying the prior probability P(H₀) by the factor P(E\H₀)/P(E) will never yield a probability that is greater than 1. Since P(E) is at least as great as P(E∩H₀), which equals P(E\H₀)·P(H₀) (see joint probability), replacing P(E) with P(E∩H₀)in the factor P(E\H₀)/P(E) will yield a posterior probability of 1. Therefore, the posterior probability could yield a probability greater than 1 only if P(E) were less than P(E∩H₀), which is never true.

The probability of E given H₀, P(E\H₀), can be represented as a function of its second argument with its first argument held at a given value. Such a function is called a likelihood function; it is a function of H₀ given E. A ratio of two likelihood functions is called a likelihood ratio, Λ. For example,

$$Λ = \frac{L ( {H}_{0} \vert E )}{L ( not {H}_{0} \vert E )} = \frac{P ( E \vert {H}_{0} )}{P ( E \vert not {H}_{0} )}$$

The marginal probability, P(E), can also be represented as the sum of the product of all probabilities of mutually exclusive hypotheses and corresponding conditional probabilities: P(E\H₀)P(H₀)+P(E\not H₀)P(not H₀).

As a result, Bayes' theorem may be rewritten as

$$\begin{matrix}P ( {H}_{0} \vert E ) = \frac{P ( E \vert {H}_{0} ) P ( {H}_{0} )}{P ( E \vert {H}_{0} ) P ( {H}_{0} ) + P ( E \vert not {H}_{0} ) P ( not {H}_{0} )} \\ = \frac{Λ P ( {H}_{0} )}{Λ P ( {H}_{0} ) + P ( not {H}_{0} )}\end{matrix}$$

With two independent pieces of evidence E₁ and E₂, Bayesian inference can be applied iteratively. According to an exemplary embodiment, the first piece of evidence may be used to calculate an initial posterior probability, and then the posterior probability may be used as a new prior probability to calculate a second posterior probability given the second piece of evidence.

Independence of evidence implies that

P(E₁, E₂\H₀)=P(E₁\H₀)×P(E₂\H₀)

P(E₁, E₂)=P(E₁)×P(E₂)

P(E₁, E₂\not H₀)=P(E₁\not H₀)×P(E₂\not H₀)

Bayes' theorem applied iteratively implies

$$P ( {H}_{0} \vert {E}_{1} , {E}_{2} ) = \frac{P ( {E}_{1} \vert {H}_{0} ) \times P ( {E}_{2} \vert {H}_{0} ) P ( {H}_{0} )}{P ( {E}_{1} ) \times P ( {E}_{2} )}$$

Using likelihood ratios, it may be found that

$$P ( {H}_{0} \vert {E}_{1} , {E}_{2} ) = \frac{{Λ}_{1} {Λ}_{2} P ( {H}_{0} )}{[ {Λ}_{1} P ( {H}_{0} ) + P ( not {H}_{0} ) ] [ {Λ}_{2} P ( {H}_{0} ) + P ( not {H}_{0} ) ]}$$

This iteration of Bayesian inference could be extended with more independent pieces of evidence.

Bayesian inference may be used to calculate probabilities for decision making under uncertainty. In addition to probabilities, a loss function may be calculated in order to reflect the consequences of making an error. Probabilities represent the chance or belief of being wrong. A loss function may represent the consequences of being wrong.

Bayesian inference has applications in artificial intelligence and expert systems. Bayesian inference techniques may be used as a part of computerized pattern recognition techniques. Bayesian methods may be connected to simulation-based Monte Carlo techniques since complex models cannot be processed in closed form by a Bayesian analysis, while the graphical model structure inherent to statistical models, may allow for efficient simulation algorithms like Gibbs sampling and other Metropolis-Hastings algorithm schemes.

Bayesian inference may be applied to statistical classification such as, e.g., but not limited to, using the naive Bayes classifier.

### Exemplary Embodiment of Computer Environment

FIG. 6 depicts an exemplary computer system that may be used in implementing an exemplary embodiment of the present invention. Specifically, FIG. 6 depicts an exemplary embodiment of a computer system 600 that may be used in computing devices such as, e.g., but not limited to, a client and/or a server, etc., according to an exemplary embodiment of the present invention. FIG. 6 depicts an exemplary embodiment of a computer system that may be used as client device 600, or a server device 600, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 600 may be shown in FIG. 6, depicting an exemplary embodiment of a block diagram of an exemplary computer system useful for implementing the present invention. Specifically, FIG. 6 illustrates an example computer 600, which in an exemplary embodiment may be, e.g., (but not limited to) a personal computer (PC) system running an operating system such as, e.g., (but not limited to) MICROSOFT® WINDOWS® NT/98/2000/XP/CE/ME/VISTA/etc. available from MICROSOFT® Corporation of Redmond, Wash., U.S.A. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 600 may be shown in FIG. 6. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as, e.g., or not limited to, that shown in FIG. 6. Services may be provided on demand using, e.g., but not limited to, an interactive television (iTV), a video on demand system (VOD), and via a digital video recorder (DVR), or other on demand viewing system.

The computer system 600 may include one or more processors, such as, e.g., but not limited to, processor(s) 604. The processor(s) 604 may be connected to a communication infrastructure 606 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 600 may include a display interface 602 that may forward, e.g., but not limited to, graphics, text, and other data, etc., from the communication infrastructure 606 (or from a frame buffer, etc., not shown) for display on the display unit 630. In an exemplary embodiment of the present invention, a dashboard user interface may be provided for user interactive access to output and to provide responses to prompts/alerts/notifications, and to receive recommendations, which may be delivered in realtime, to, e.g., health care providers, such as a surgeon while in surgery. According to one exemplary embodiment, the interface may allow for input output using any of various convention interface devices such as, e.g., a stylus, a pen, a key, a mouse, a voice-recognition and voice interface, graphical buttons, audio and/or visual output.

The computer system 600 may also include, e.g., but may not be limited to, a main memory 608, random access memory (RAM), and a secondary memory 610, etc. The secondary memory 610 may include, for example, (but not limited to) a hard disk drive 612 and/or a removable storage drive 614, representing a floppy diskette drive, a magnetic tape drive, an optical disk drive, a compact disk drive CD-ROM, etc. The removable storage drive 614 may, e.g., but not limited to, read from and/or write to a removable storage unit 618 in a well known manner. Removable storage unit 618, also called a program storage device or a computer program product, may represent, e.g., but not limited to, a floppy disk, magnetic tape, optical disk, compact disk, etc. which may be read from and written to by removable storage drive 614. As may be appreciated, the removable storage unit 618 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and a memory chip, etc.

In alternative exemplary embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 622 and interfaces 620, which may allow software and data to be transferred from the removable storage unit 622 to computer system 600.

Computer 600 may also include an input device 616 such as, e.g., (but not limited to) a mouse or other pointing device such as, e.g., or not limited to, a digitizer, and a keyboard or other data entry device (not shown), and others such as, e.g., voice recognition, etc.

Computer 600 may also include output devices, such as, e.g., (but not limited to) display 630, and display interface 602. Computer 600 may include input/output (I/O) devices such as, e.g., (but not limited to) communications interface 624, cable 628 and communications path 626, etc. These devices may include, e.g., but not limited to, a network interface card, and modems (neither may be labeled). Communications interface 624 may allow software and data to be transferred between computer system 600 and external devices.

In this document, the terms “computer program medium” and “computer readable medium” may be used to generally refer to media such as, e.g., but not limited to removable storage drive 614, a hard disk installed in hard disk drive 612, and signals 628, etc. These computer program products may provide software to computer system 600. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements may be in direct physical or electrical contact with each other. “Coupled” may mean that two or more elements may be in direct physical or electrical contact. However, “coupled” may also mean that two or more elements may be not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as, e.g., or not limited to, “processing,” “computing,” “calculating,” “determining,” or the like, refer to the action and/or processes of a computer or computing system, or similar electronic computing device, that manipulate and/or transform data represented as physical, such as, e.g., or not limited to, electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

### Exemplary Definitions

“Artificial intelligence” (or AI) may be the study and design of intelligent agents, where an intelligent agent may be a system that perceives its environment and takes actions which maximizes its chances of success. John McCarthy coined the term in 1956 defining AI as “the science and engineering of making intelligent machines.” Other names for the field have been proposed, such as, e.g., but not limited to, computational intelligence, synthetic intelligence, or computational rationality. The term artificial intelligence may be also used to describe a property of machines or programs: the intelligence that the system demonstrates.

“Artificial neural network” (ANN), often just called a “neural network” (NN), may be a mathematical model or computational model based on biological neural networks. An ANN may include an interconnected group of artificial neurons and may process information using a connectionist approach to computation. In most cases an ANN may be an adaptive system that may change its structure based on external or internal information that flows through the network during the learning phase. (The term “neural network” can also mean biological-type systems.) In more practical terms neural networks may be non-linear statistical data modeling tools. Neural networks can be used to model complex relationships between inputs and outputs or to find patterns in data.

“Bayesian inference” may be a statistical inference in which evidence or observations may be used to update or to newly infer the probability that a hypothesis may be true. The name “Bayesian” comes from the frequent use of Bayes' theorem in the inference process. Bayes' theorem was derived from the work of the Reverend Thomas Bayes.

“Bayesian probability” may be an interpretation of probability calculus which holds that the concept of probability can be defined as the degree to which a person (or community) believes that a proposition is true. Bayesian theory also suggests that Bayes' theorem can be used as a rule to infer or update the degree of belief in light of new information.

“Data mining” has been defined as the nontrivial extraction of implicit, previously unknown, and potentially useful information from data and the science of extracting useful information from large data sets or databases. Data mining involves sorting through large amounts of data and picking out relevant information. Data mining may be used by business intelligence organizations, and financial analysts, and may be used in the sciences to extract information from enormous data sets generated by experimental and observational methods, according to an exemplary embodiment.

“Expert system”, also known as a knowledge based system, may be a computer program that may contain a database of a subject-specific knowledge, and may contain the knowledge and analytical skills of one or more human experts. This class of program was first developed by researchers in artificial intelligence during the 1960s and 1970s and applied commercially throughout the 1980s.

“Heuristic” may be a rule of thumb, and can mean any algorithm that gives up finding the optimal solution for an improvement in run time, or a heuristic can be a function that estimates the cost of the cheapest path from one node to another.

“Inference rule” may include a statement that has two parts, an if-clause and a then-clause. This rule may be what gives expert systems the ability to find solutions to diagnostic and prescriptive problems. An example of an inference rule is: If the restaurant choice includes French, and the occasion is romantic, then the restaurant choice is definitely Paul Bocuse. An expert system's rulebase may be made up of many such inference rules. The inference rules may be may be entered as separate rules and an inference engine may use the inference rules together to draw conclusions. Because each rule may be a unit, rules may be deleted or added without affecting other rules (though deleting or adding should affect which conclusions may be reached). One advantage of inference rules over traditional programming may be that inference rules use reasoning which may more closely resembles human reasoning. Thus, when a conclusion may be drawn, it may be possible to understand how this conclusion was reached. Furthermore, because the expert system uses knowledge in a form similar to the expert, it may be easier to retrieve this information from the expert.

“Inference engine” may be a computer program that tries to derive answers from a knowledge base. An inference engine may be the “brain” that expert systems use to reason about the information in the knowledge base for the ultimate purpose of formulating new conclusions. An inference engine may have three main elements. They are: 1) An interpreter—The interpreter may execute the chosen agenda items by applying the corresponding base rules. 2) A scheduler —The scheduler may maintain control over the agenda by estimating the effects of applying inference rules in light of item priorities or other criteria on the agenda. 3) A consistency enforcer—The consistency enforcer may attempt to maintain a consistent representation of the emerging solution.

“Knowledge base” (or knowledgebase; abbreviated KB, kb or Δ) may include a special kind of database for knowledge management. The knowledgebase may provide the means for the computerized collection, organization, and/or retrieval of knowledge.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for improving the delivery of healthcare services comprising:
a) capturing data associated with at least one health care services event, wherein said data comprises at least one aspect of said at least one health care services event;
b) categorizing, into at least one category, said at least one aspect of said at least one health care services event;
c) analyzing said data associated with said categorized health care services event comprising:
i) determining a correlation between said at least one aspect of said data to said at least one category, and
ii) determining any cause and effect relationship between said at least one aspect and said at least one category; and
d) recommending at least one course of action based on said at least one aspect having said correlation and said cause and effect relationship to said at least one category.

2. The method according to claim 1, wherein said (a) comprises at least one of:
i) capturing data associated with at least one health care services event, wherein said at least one health care services event comprises at least one of:
at least one event;
a plurality of events;
at least one pre-operative event;
at least one post-operative event;
at least one operative event;
at least one pre-procedure event;
at least one post-procedure event;
at least one procedure;
at least one emergency room procedure;
at least one triage event;
at least one nursing station event;
at least one patient/nurse interaction event; and/or
at least one healthcare provider/patient interaction event;
ii) capturing said at least one aspect of said data, wherein said at least one aspect comprises:
at least one temporal duration;
at least one quantity of time;
at least one quantity of health care resources used;
at least one type of health care resource used;
at least one health care provider preference;
at least one health care facility preference;
at least one preference;
at least one norm;
at least one procedure;
at least one of a minimum, a mean, and/or a maximum quantity of at least one resource;
at least one location;
at least one proximity between a plurality of resources;
at least one change of location by a resource;
at least one rate of change of said location;
at least one movement from a first location to a second location of a resource;
at least one regulatory requirement;
at least one order; and/or
at least one protocol;
iii) capturing said data, wherein said data relates to at least one of a plurality of entities comprising at least one of:
a health care resource,
a patient,
a health care provider,
a staff member;
a location;
a data processing system;
a healthcare system;
a person;
a system;
a supply; and/or
at least one piece of equipment;
iv) capturing said data, wherein said capturing comprises at least one of:
tracking said data;
collecting said data;
aggregating said data;
storing said data;
transmitting said data;
capturing said data over time;
capturing said data by location; and/or
capturing said data by location and time; and/or
v) capturing said data wherein said data comprises at least one of:
at least one medical record;
at least one physical record;
at least one electronic record;
a patient medical record;
at least one electronic medical record;
at least one personal health record (PHR);
at least one location data;
at least one temporal data;
at least one radio frequency identification (RFID) device;
at least one health level seven (HL-7) protocol message;
at least one data from any hospital system;
at least one standards-based healthcare data;
at least one American Society for Testing and Materials (ASTM) based data;
at least one Digital Imaging and Communications in Medicine (DICOM) based data;
at least one entity preference;
at least one healthcare facility protocol;
at least one protocol;
at least one order;
at least one procedure;
at least one bar code;
at least one regulatory data;
at least one other input from an existing hospital information system;
at least one aspect of data;
at least one demographic of an entity;
at least one experience data;
at least one expertise data; and/or
data from another system.

3. The method according to claim 1, wherein said (b) comprises at least one of:
i) comparing said at least one aspect of said health care services event to at least one preference, and
assigning said at least one aspect of said at least one health care services event to said at least one category based on said comparing;
ii) comparing a first at least one aspect of said health care services event to a second at least one aspect of a second said health care services event, and
assigning said first at least one aspect of said health care services event to said at least one category based on said comparing;
iii) comparing at least one aspect of a first said health care services event to at least one aspect of a second said health care services event, and
assigning said at least one aspect of said first health care services event to said at least one category based on said comparing; and/or
iv) categorizing along at least one of:
a continuum of said at least one categories, wherein said continuum comprises at least one of:
a multi-variate category;
a range of categories;
a continuum from optimal to unacceptable; and/or
a discrete set of said categories comprises at least one of:
a binary category; and/or
at least three discrete categories.

4. The method according to claim 3, wherein said comparing comprises at least one of:
(i) comparing to said at least one preference, wherein said preference comprises at least one of:
comparing whether a duration of said health care services event was completed in an allotted time preference;
comparing health care resources used during said health care services event to an allotted amount of resources preference;
comparing an occurrence of said health care services event to a defined point in time preference;
comparing a proximity aspect to a defined proximity preference; and/or
comparing a location of said health care services event to a defined location preference; and/or
(ii) comparing to said at least one preference, wherein said preference is established by at least one of:
a health care facility;
a physician preference;
a nurse preference;
a health care provider preference;
an iterative preference; and/or
a recommended preference.

5. The method according to claim 1, wherein said (c) comprises at least one of:
i) performing at least one of:
stochastic analysis;
Bayesian analysis;
deterministic analysis; and/or
non-deterministic analysis;
ii) iteratively improving said at least one aspect;
iii) learning an improved health care preference;
iv) performing heuristic analysis on said data;
v) iteratively improving a preference related to said at least one healthcare services event; and/or
vi) optimizing utilization of health care service resources associated with said at least one health care services event.

6. The method according to claim 1, wherein said (d) comprises at least one of:
i) recommending at least one change to said capturing comprising at least one of:
adding a new at least one datapoint to capture, and/or
deleting an instance of said at least one datapoint;
ii) recommending at least one change to said capturing comprising at least one of:
adding a new at least one aspect,
deleting an existing of said at least one aspect, and/or
modifying said at least one aspect;
iii) recommending at least one change to said categories comprising at least one of:
adding a new at least one category,
deleting an existing of said at least one category, and/or
modifying said at least one category;
iv) recommending said at least one course of action to effect a change in said at least one health care services event; and/or
v) minimizing at least one of an underlying activity, and/or subevent leading to at least one of a negative data point and/or a negative aspect, wherein said negative datapoint and/or said negative aspect is associated with any negative category;
vi) maximizing at least one of an underlying activity and/or subevent leading to a at least one of a positive data point and/or a positive aspect, wherein said positive datapoint and/or said positive aspect is associated with any positive category;
vii) recommending in at least one of real time, and/or retroactively; and/or
viii) recommending said course of action directed at improving utilization of health care facility resources.

7. The method according to claim 1, further comprising
e) notifying at least one entity wherein said notifying comprises at least one of:
i) notifying of said at least one course of action;
ii) alerting said at least one entity;
iii) providing output to at least one entity;
iv) providing interactive prompting to said at least one entity;
v) allowing interactive deferral by said at least one entity;
vi) providing prompting to said at least one entity;
vii) providing output data in an easily accessible and interactive format;
viii) notifying in at least one of real time, and/or retroactively; and/or
ix) notifying of said course of action directed at improving utilization of health care facility resources.

8. The method according to claim 7, wherein said (e) comprises at least one of:
x) providing a dashboard user interface application;
xi) providing an executive information system (EIS);
xii) providing a graphical user interface (GUI);
xiiii) providing an interface customized to user needs and/or preferences;
xiv) providing a dashboard and/or interactive, easy to use user interface elements;
xv) providing an easy to change and/or customize interface; and/or
xvi) a dashboard customizable for the needs of an entity.

9. The method according to claim 1, further comprising
e) ranking, based on at least one metric, at least one of:
a plurality of entities,
at least one healthcare service facility,
at least one department of said at least one healthcare service facility,
said at least one healthcare service event; and/or
said at least one health care service event across a plurality of healthcare service facilities,
wherein said ranking comprises at least one of a comparative ranking and/or a benchmark.

10. The method of claim 1, wherein said data comprises location based data comprising at least one of:
a location of each of said plurality of entities;
a temporal relationship associated with said each of said plurality of entities being located at said location;
a temporal extent of said each of said plurality of entities being located at said location;
a proximity between at least two of said plurality of entities;
a temporal extent of said proximity;
a temporal relationship associated with said proximity;
a location of said at least one health care service delivery event;
a temporal extent of said at least one health care service delivery event; and/or
a temporal relationship associated with said health care service delivery event.

11. The method according to claim 10, wherein said location based data comprises at least one of:
location based data in at least two dimensions;
location based data in at least three dimensions;
location based data in at least two dimensions plus time;
a geosynchronous positioning satellite (GPS) data;
a real time location system (RTLS) data;
a radio frequency identification (RFID) data;
a wireless and/or wired network based data;
a WI-FI based location data;
a WI-MAX based location data;
an ultra-wideband location data; and/or
an auto identification system (AIS).

12. The method according to claim 1, wherein said health care services event is delivered by a health care resource comprising at least one of:
a healthcare provider;
a healthcare worker;
a physician;
a nurse;
a care giver;
a surgeon;
an orderly;
transportation;
a therapist;
an occupational therapist (OT);
a physical therapist (PT);
a pulmonary therapist (PT);
a pulmonologist;
an oncological surgeon;
a cardiac surgeon;
an executive;
an administrator;
an ancillary service provider;
a physician's assistant;
an emergency medical technician (EMT);
a first responder;
a police officer; and/or
a clinician.

13. The method according to claim 1, wherein said health care services event is delivered by a health care resource comprising at least one of:
a medical device;
a medical supply;
a piece of equipment;
a specimen;
a lab specimen;
a medication;
an instrument;
a bed;
a gurney;
an imaging device comprising at least one of an X-Ray device, a CT scan device, an MRI image device, a scanned image device, an electronic image device, and/or another image device;
a waveform comprising at least one of an EKG, an ECG, another waveform;
a medical device comprising at least one of a pulmonary function monitor, a heart monitor, a wireless RF monitor, and/or a wired monitor;
a physical record;
an electronic medical record;
a personal health record;
a patient medical record; and/or
an RFID tag;
wherein said health care services event is delivered by a health care facility comprising at least one of:
a hospital;
a health care system;
an integrated delivery network;
a plurality of hospitals;
a nursing home;
a critical care service;
an assisted living facility;
a hospice service;
a physical therapy clinic;
a therapy clinic;
a clinic;
a medical supplier;
a pharmacy;
a doctor's office;
a dental office;
a home;
a remotely monitored location;
a remote consultation location;
a home health care service; and/or
a health care clinic; and
wherein said health care services event is delivered by a health care facility comprising a plurality of departments comprising at least one of:
an operating room;
a nursing station;
an emergency department;
a critical care unit;
a cardiac care unit;
an intensive care unit;
a nursery;
a pediatric department;
a maternity department;
a surgery department;
a surgery center;
an oncology department;
a geriatrics department;
a physical therapy department;
an occupational therapy department;
an orthopedic department;
a radiology department;
a ward (inpatient);
a clinic (outpatient);
a medical office;
a physician's office;
a medical specialty department;
a health care facility room;
a care delivery room;
a recovery room;
a waiting room;
a pre-operative room;
a post-operative room;
another department; and/or
a patient room.

14. The method of claim 1, further comprising:
e) identifying at least one health care service preference relating to said at least one aspect of said at least one health care services event.

15. A computer program product embodied on a computer readable medium comprising program logic which when executed on a processor performs a method for improving the delivery of healthcare services, said method comprising:
a) capturing data associated with at least one health care services event, wherein said data comprises at least one aspect of said at least one health care services event;
b) categorizing, into at least one category, said at least one aspect of said at least one health care services event;
c) analyzing said data associated with said categorized health care services event comprising:
i) determining a correlation between said at least one aspect of said data to said at least one category, and
ii) determining any cause and effect relationship between said at least one aspect and said at least one category; and
d) recommending at least one course of action based on said at least one aspect having said correlation and said cause and effect relationship to said at least one category.

16. A system for improving the delivery of healthcare services comprising:
means for capturing data associated with at least one health care services event, wherein said data comprises at least one aspect of said at least one health care services event;
means for categorizing, into at least one category, said at least one aspect of said at least one health care services event;
means for analyzing said data associated with said categorized health care services event comprising:
means for determining a correlation between said at least one aspect of said data to said at least one category, and
means for determining any cause and effect relationship between said at least one aspect and said at least one category; and
means for recommending at least one course of action based on said at least one aspect having said correlation and said cause and effect relationship to said at least one category.

17. The system according to claim 16, further comprising:
an analytics system adapted for assisting an entity to optimize resource utilization via a performance analytics engine (PAE) infrastructure and services system, said analytics system comprising at least one of:
at least one transaction source data feed (TSDF) non-location based ordering system,
at least one transaction source extractor means for extracting transaction data from said transaction source data feed,
at least one transaction source normalizer means for preparing data for analysis, and for normalizing transaction data from said transaction source extractor, and
at least one transaction source aggregation engine means for homogeneous collecting, screening, and sorting through large volumes of normalized transaction data from said transaction source normalizer,
wherein said at least one transaction source aggregation engine means uses proprietary algorithms based on at least one of Bayesian analysis and/or heuristic methods; and/or
at least one location source data feed (LSDF) location based system comprising data relating to location of at least one of a patient location, a device location, and/or a clinician location,
at least one location source extractor means for extracting location data from said location source data feed,
at least one location source normalizer means for normalizing location data from said location source extractor, and
at least one location source aggregation engine means for collecting heterogeneously, screening, and sorting through large volumes of normalized location data from said location source extractor,
wherein said at least one location source aggregation engine uses proprietary algorithms based on Bayesian analysis and/or heuristic methods; and
at least one interface means for interactive entry and/or acceptance by at least one of an administrative user, a healthcare provider, a support staff person, and/or a health care facility system, wherein said interactive entry and/or acceptance is of at least one of at least one expected event, at least one rule, at least one time measure, at least one outcome, and/or at least one preference or set of preferences.

18. The system according to claim 17, wherein said transaction source data comprises at least one data from at least one transaction system regarding at least one of:
an admission/discharge/transfer;
an order,
a result,
a computerized physician order entry (CPOE),
a scheduled event,
an appointment,
a patient movement, and/or
a device movement.

19. The system according to claim 17, wherein said at least one LSDF comprises location source data comprising a location data set relating to a location of at least one of:
at least one patient;
at least one person;
at least one employee;
at least one non-employee;
at least one contractor;
at least one affiliate;
at least one business partner;
at least one resident;
at least one healthcare worker;
at least one healthcare provider;
at least one living being;
at least one supply;
at least one piece of equipment; and/or
at least one device.

20. The system of claim 17, wherein said performance analytics engine comprises at least one of:
at least one means for moving and/or extracting data;
at least one means for normalizing data;
at least one means for aggregating data;
at least one means for matching data and expected events;
at least one means for matching expected events and actual events;
at least one means for preparing at least one of an alarm, a notification, a recommendation, and/or a message to at least one of individuals and/or systems;
at least one means for delivering a message to at least one of a person, interface and/or a system;
at least one means for updating an algorithm;
at least one means for learning;
at least one means for providing a heuristic method;
at least one means for correlating;
at least one means for determining a relative importance of a deviations;
at least one application service provider (ASP) service;
at least one software as a service (SaaS) based service;
at least one on demand service offering;
at least one utility computing offering;
at least one service oriented architecture (SOA) based offering;
at least one knowledge base (KB);
at least one rules database;
at least one inference engine
at least one Bayesian inference engine; and/or
at least one means for providing an expert system.

21. The system according to claim 17, wherein said at least one performance analytics engine comprises at least one of:
means for matching clinical orders and/or procedures,
wherein said clinical orders and/or procedures comprise at least one of:
a lab test, an x-ray, an image, a magnetic resonance image (MRIs),
a computer tomography (CT) scan, an ultrasound, patient data, a scheduled event, an unscheduled event, a movement, a transfer, and/or an expected event;
means for matching an expected event with an actual event;
means for comparing an expected event with actual event;
means for matching expected and actual event deviations;
means for preparing an alarm, a message, an alert, a prompt, an indication, a recommendation, and/or a notification,
wherein said means for preparing comprises means for using a delivery mechanism to notify individuals of deviations with or without appropriate remedial actions;
means for preparing an alarm and/or a message using a delivery mechanism to notify health care facility systems; and
means for updating an algorithm, for using a heuristic method, for learning, for iteratively learning, for correlating, and/or for determining a relative importance of a deviation.
